(19) United States
(12) Patent Application Publication
(10) Pub. No.: US 2026/0324638 A1
(43) Pub. Date: Oct. 22, 2026

(54) LIQUID AGRICULTURAL FORMULATION CONTAINING A PPO-INHIBITOR

(71) Applicant: BASF AGRO B.V., Arnhem (NL)

(72) Inventors: Ulrich Steinbrenner, Ludwigshafen (DE); Joerg Steuerwald, Limburgerhof (DE)

(21) Appl. No.: 19/485,344

(22) PCT Filed: May 23, 2024
(86) PCT No.: PCT/EP2024/064300

§ 371 Date: Nov. 18, 2025

(30) Foreign Application Priority Data
May 24, 2023 (EP) 23175084.5

(51) Int. Cl. A01N 43/54; A01N 25/04; A01N 25/22; A01P 13/00

(52) U.S. Cl. CPC A01N 43/54; A01N 25/04; A01N 25/22; A01P 13/00

(57) ABSTRACT

The present invention relates to liquid agricultural formulations which contain at least one herbicide of the group of inhibitors of protoporphyrinogen-IX-oxidase (PPO-inhibitors), which are in particular selected from saflufenacil and trifludimoxazin, and a solvent-emulsifier combination. The present invention also relates to a process for preparing the liquid agricultural formulation containing at least one herbicide of the group of inhibitors of protoporphyrinogen-IX-oxidase. Moreover, the present invention relates to use of said liquid formulation for controlling growth of undesired plants, and to a method for controlling growth of undesired plants comprising applying said formulation onto the undesired plants, on parts of the undesired plants or on the area where the undesired plants grow or may grow.

The present invention relates to liquid agricultural formulations which contain at least one herbicide of the group of inhibitors of protoporphyrinogen-IX-oxidase (PPO-inhibitors), which are in particular selected from saflufenacil and trifludimoxazin, and a solvent-emulsifier combination. The present invention also relates to a process for preparing the liquid agricultural formulation containing at least one herbicide of the group of inhibitors of protoporphyrinogen-IX-oxidase. Moreover, the present invention relates to use of said liquid formulation for controlling growth of undesired plants.

### BACKGROUND ON THE INVENTION

Some organic agrochemical pesticide compounds, like herbicides, fungicides, insecticides—or pesticides in general—are often applied in the form of a dilute aqueous composition in order to achieve a good interaction with the target organisms, which can be weeds, fungi or pests like invertebrate pests. While some of these agrochemical pesticides are water-soluble, a considerable amount of organic pesticide compounds are only sparingly or even insoluble in water. In particular, herbicides of the group of PPO-inhibitors, especially saflufenacil and trifludimoxazin, are only sparingly soluble in various liquid media, particularly in aqueous media. Therefore, it is extremely challenging to provide a stable liquid formulation containing PPO-inhibitors, especially saflufenacil or trifludimoxazin.

Organic herbicides having a limited solubility in water are often formulated as wettable powders or granules, as emulsifiable concentrates (EC), as water-dispersible granules (WDG) or as aqueous suspension concentrates (SC). Such formulations of insoluble or sparingly water-soluble herbicides are generally diluted with water for use in the field to a predetermined concentration and often produced as a spray liquid.

Suspension concentrates are formulations wherein the active ingredient is present in the form of finely divided solid particles which are suspended in an aqueous dispersing medium utilizing surface-active compounds, i.e. surfactants, such as wetting agents, dispersants and rheological or suspending aids for stabilizing the active ingredient particles in the dispersing medium. However, problems are often encountered with SC's as a result of settling during prolonged storage or storage at elevated temperatures, the resistance of settled particles to re-suspension and the formation of crystalline material upon storage. As a consequence, the formulations are difficult to handle and the bioefficacy may be inconsistent, which is in particular problematic for highly active modern herbicides. Moreover, SC's are limited to actives that have a relatively high melting point. Most agrochemicals are sparingly water-soluble and become partly “deactivated” with water when formulated as an aqueous SC.

In wettable powders or granules the herbicide compound is present in the form of particles. When wettable powders or granules are diluted in water for field application, the particles of the powder or granules have to disintegrate in water to achieve a uniform distribution of the herbicide compound in the aqueous dilution. Unfortunately, disintegration of the particles is often hampered if the solid formulation has been stored for prolonged time or in opened packages. Hindered disintegration may result in inconsistent bioefficacy.

Emulsifiable concentrates are non-aqueous liquid formulations, where the herbicide compound is dissolved in a mixture of non-polar organic solvents and emulsifiers. Upon dilution of emulsifiable concentrates with water, an oil-in-water emulsion is formed. Unfortunately, emulsifiable concentrates tend to be instable upon storage, as the surfactants and the solvents may suffer phase separation. As a result, emulsification in water may be hampered, which may again result in inconsistent bioefficacy. Apart from that, the large amounts of non-polar solvents may be undesirable from hygiene, environmental safety and health protection at workplace standpoints.

WO 2011/023759 describes an aqueous suspension concentrate formulation for plant protection comprising saflufenacil in the form of its crystalline anhydrate; at least one non-ionic surfactant selected from polyoxyethylene-polyoxy-C₃-C₄-alkylene blockcopolymers; at least one anionic surfactant comprising at least one arylsulfonate group; and water; wherein the pH value of the formulation is in the range of 3 to 7.

WO 2011/070051 describes a liquid suspension concentrate formulation for plant protection comprising saflufenacil in the form of the crystalline anhydrate; at least one diluent selected from: hydrocarbon solvents having a boiling point of at least 100° C.; and C₁-C₈-alkyl esters of C₈-C₂₆-fatty acids, mono- and di-C₁-C₄-alkyl amides of C₈-C₂₆-fatty acids; at least two different non-ionic surfactants selected from poly-ethoxylate-co-C₃-C₄-alkoxylates of C₃-C₂₀-alkanols, polyethoxylates of C₈-C₂₂-alkanols, polyester-polyoxyethylene block copolymers, polyethoxylates of mono-, di- or tristyryl phenols and polyethoxylates of vegetable oils; and at least one anionic surfactant selected from C₁-C₁₆-alkylarene sulfonates.

Aqueous multiphase formulations, wherein the herbicide compound is dissolved in an organic phase, such as microemulsions (also termed ME formulations) or even liquid homogenous formulations can principally circumvent some of the aforementioned disadvantages.

WO 2021/038439 describes a soluble liquid (SL) composition comprising saflufenacil and an organic base, and a use of an amine salt of saflufenacil for preparing the soluble liquid composition. The saflufenicil of this SL formulation is water-free and dissolved in the organic base, and the SL-formulation is in a non-aqueous medium. Compared to the water-based suspension concentrate (SC) formulation of saflufencil, the SL-formulation of saflufenacil is much more potent and effective against weed.

However, the development of such above-mentioned formulations, e.g. stable suspension, microemulsions, emulsion concentrates and liquid homogenous formulation, of herbicide of the group of PPO-inhibitors, especially saflufenacil, is a perpetual challenge. Especially, regarding the stability of such formulations of herbicides of the group of PPO-inhibitors, these are not always satisfactory, and unmixing (separation) or crystallization of the herbicide may occur. Moreover, dilution stability of such formulations is sometimes insufficient, i.e. the herbicides of the group of PPO-inhibitors are sparingly water-soluble and thus tend to segregate upon or after dilution with water, in particular, when the formulation is highly loaded with the herbicide of the group of PPO-inhibitors. A further problem is that certain types of solvents which provide stable formulations may be problematic in view environmental requirements and working hygiene.

### SUMMARY OF THE INVENTION

There is an ongoing need for liquid formulations of PPO inhibitors, in particular liquid formulations of saflufenacil or trifludimoxazin, which provide sufficient stability in terms of chemical stability and physical stability and which allow for high loads with these pesticides. Moreover, the formulations should have high dilution stability, i. e. upon dilution with water they form a stable emulsion or dispersion of the PPO inhibitor without forming sediment or creaming.

It is, therefore, an object of the present invention to provide stable herbicide formulations of at least one herbicide of the group of PPO-inhibitors, especially of saflufenacil and/or trifludimoxazin. Such herbicide formulation should especially exhibit both chemical and physical stability, in particular a good storage stability, as well as high dilution stability.

Surprisingly, it has now been found that liquid formulations of at least one herbicide of the group of PPO-inhibitors, which contain a solvent/emulsifier combination, as defined herein, and optionally contain moreover at least one organic acid with a pKA in the range of 1 to 6, in particular in the range of 2 to 5, exhibit excellent stabilities, especially outstanding chemical and physical stability and dilution stability. In particular, the liquid formulation according to the present invention show a low degration of the herbicide component contained in the formulation. Furthermore, said liquid formulation has high biological effectiveness and high loading with herbicidal active ingredients. The liquid formulations of the present invention show good dilution stability and the aqueous dilutions remain stable in a diluted form and therefore, they are easily to handle and apply by the users.

Therefore, the present invention relates to a liquid formulation comprising,
a) at least one herbicide of the group of PPO-inhibitors, as a component A),
b) optionally at least one organic acid having a pKA value in the range of 1 to 6, in particular in the range of 3 to 5, as a component B)
c) a solvent-emulsifier combination, as a component C), comprising
   c1) water, as a component C1),
   c2) at least one water-miscible organic solvent, as a component C2),
   c3) at least one first emulsifier, as a component C3), which is selected from the group consisting of C₆-C₂₅-alkanol alkoxylates, C₆-C₂₅-alkenol alkoxylates and mixtures thereof,
   c4) at least one second emulsifier, as a component C4), which is selected from the group consisting of arylphenol ethoxylates, in particular from distyrylphenol ethoxylate, tristyrylphenol ethoxylate and mixtures thereof, and
   c5) at least one C₆-C₂₀-fatty acid-C₁-C₄-alkyl ester, as a component C5), in particular at least one C₆-C₂₀-fatty acid methyl or ethyl ester, as a component C5),
   where in a particular embodiment the component C5) comprises at least one C₁₈-fatty acid-C₁-C₄-alkyl ester;
   and where in an another particular embodiment the component C5) is a C₆-C₁₀-fatty acid-C₁-C₄-alkyl ester, which preferably comprises at least one C₈-C₁₀-fatty acid-C₁-C₄-alkyl ester.

Furthermore, the present invention also relates to a process for preparing the liquid formulation as defined herein which comprises mixing the components A), C) and, if component B) is to be contained in the formulation, also B) (otherwise only A) and C), of course).

A further aspect of the present invention relates to the use of said liquid formulation, as defined herein, for controlling growth of undesired plants.

Yet a further aspect of the present invention relates to a method for controlling growth of undesired plants comprising the step of applying the formulation, as defined herein, onto the undesired plants, on parts of the undesired plants or on the area where the undesired plants grow or may grow.

The liquid formulations according to the present invention have several benefits. In particular, they exhibit an excellent dilution stability and have a good storage stability both in terms of chemical and physical stability. In particular, the liquid formulation of the present invention is stable against phase separation upon storage and does not show degradation of the PPO inhibitor when the formulation is stored at elevated temperatures. Moreover, the liquid formulations of the present invention show good dilution stability and the aqueous dilutions remain stable in a diluted form and therefore, they are easy to handle and apply by the users.

### DETAILED DESCRIPTION OF THE INVENTION

As used herein, “herbicide” refers to one or more agents, compounds and/or compositions having herbistatic and/or herbicidal activity.

As used herein, the terms “controlling” and “combating” are synonyms, referring to inhibition of growth, control of growth, reduction of growth or complete destruction of undesired plants. Preferably, the growth of the harmful plant(s) is essentially diminished (60-79%), more preferably the growth of the harmful plant(s) is largely or fully suppressed (80-100%), and in particular the growth of the harmful plant(s) is almost fully or fully suppressed (90-100%).

As used herein, the terms “undesirable vegetation”, “undesirable species”, “undesirable plants”, “undesired plants”, “harmful plants”, “undesirable weeds”, “volunteer plants” or “harmful weeds” are used synonymously.

As used herein, “post emergence” refers to an herbicide treatment that is applied to an area after the weeds have germinated and emerged from the ground or growing medium.

As used herein, “burndown” refers to when an herbicide is used to reduce weed presence at the time of treatment. Burndown is often used in minimum or no-till fields because the weeds cannot be managed by tilling the soil. The burndown application may be used post-harvest and/or prior to crop emergence. Burndown is especially useful against weeds that emerge between growing seasons.

In general, terms mentioned in their plural form refer to a situation wherein only the singular term applies as well unless specifically expressed otherwise.

In the context of the present invention, the term “liquid formulation” refers to a formulation which is liquid at least at ambient conditions, i.e. at 20° C. and 1013 mbar, in particular at a temperature of 0° C. or higher. In particular, a liquid formulation is understood as a formulation having a dynamic viscosity determined at 20° C. at a shear rate of 100 s⁻¹ of at most 2000 mPa·s, in particular of at most 1000 mPa·s and typically in the range of 20 to 2000 mPa·s.

The formulations of the present invention are virtually homogeneous. The term “homogeneous” is understood that all non-liquid components of the formulation, especially the PPO inhibitor herbicide is dissolved in the liquid phase of the formulation at 20° C. and 1013 mbar or at least forms a stable colloidal solution in the solvent/emulsifier composition forming the fluid phase of the formulation. In particular, the formulation is characterized by having either no measurable particle size or a particle size of at most 50 nm, as determined at a temperature in the range of 20 to 25° C. by light scattering. In particular, the formulation is virtually transparent or translucent, i.e. the turbidity of the formulation, as expressed in light transmittance (LD100 value), as determined photometrically with 1 cm cuvette, is at least 10%, preferably at least 50%, more preferably at least 70%.

The liquid formulations according to the invention have a good dilution stability. Dilution stability means that the liquid formulations when diluted in water form a stable emulsion or dispersion of the pesticide without precipitation or flocculation. Thus dilution stability ensures that the spray liquors obtained by dilution of the formulation with water will not block spray nozzles. Dilution stability can be assessed by dilution of the liquid formulation with standard water at 30° C. to the intended concentration in a scaled cylinder. 30 minutes after dilution the appearance of any separation or sediment is assessed. Then, the formulation is filtered through a 45 μm sieve and the residue on the sieve is quantified. In particular, the amount of residue on the 45 μm sieve observed is at most 2% by weight, particularly at most 1% by weight, especially at most 0.5% by weight, based on the total weight of the tested liquid formulation of the invention. In particular, no residue is observable after filtering the aqueous dilution of the formulation of the invention through a 45 μm sieve. The CIPAC MT 36.3 test can be used.

Here and throughout the specification, the prefixes Cₙ-Cₘ used in connection with compounds or molecular moieties each indicate a range for the number of possible carbon atoms that a molecular moiety or a compound can have. The term “C₁-Cₙ alkyl” denominates a group of linear or branched saturated hydrocarbon radicals having from 1 to n carbon atoms. The term “Cₙ/Cₘ alkyl” denominates a mixture of two alkyl groups, one having n carbon atoms while the other having m carbon atoms.

For example, the term C₁-C₂₀ alkyl denominates a group of linear or branched saturated hydrocarbon radicals having from 1 to 20 carbon atoms, while the term C₁-C₄ alkyl denominates a group of linear or branched saturated hydrocarbon radicals having from 1 to 4 carbon atoms and the C₅-C₂₀ alkyl denominates a group of linear or branched saturated hydrocarbon radicals having from 5 to 20 carbon atoms. Examples of alkyl include but are not limited to methyl, ethyl, n-propyl, isopropyl, n-butyl, sec-butyl, isobutyl, tert-butyl, 2-methylpropyl (isopropyl), 1,1-dimethylethyl (tert-butyl), pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, 2-heptyl, n-octyl, 2-octyl, 2-ethylhexyl, nonyl, isononyl, decyl, undecyl, dodecyl, tridecyl, isotridecyl, tetradecyl, pentadecyl, hexadecyl, heptadecyl, octadecyl, nonadecyl, eicosyl, heneicosyl docosyl and in case of nonyl, isononyl, decyl, undecyl, dodecyl, tridecyl, isotridecyl, tetradecyl, pentadecyl, hexadecyl, heptadecyl, octadecyl, nonadecyl, eicosyl, heneicosyl docosyl their isomers, in particular mixtures of isomers such as “isononyl”, “isodecyl”. Examples of C₁-C₄-alkyl are for example methyl, ethyl, propyl, 1-methylethyl, butyl, 1-methylpropyl, 2-methylpropyl or 1,1-dimethylethyl.

The liquid formulation of the invention comprises at least one herbicide of the group of inhibitors of protoporphyrinogen-IX-oxidase (PPO inhibitor). PPO inhibitors are compounds which have a mode of action comprising the inhibition of a step of the chlorophyll biosynthesis in plants and which belong to the group E of the HRAC classification system (see HRAC, Classification of Herbicides According to Mode of Action, http://www.plantprotection.org/hrac/MOA.html).

PPO inhibitors have typically the following chemical formula (I):

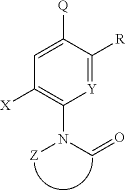

where the moiety

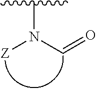

represents an N-bound heterocycle of the formula (a), (b), (c), (d), (e), (f) or (g)

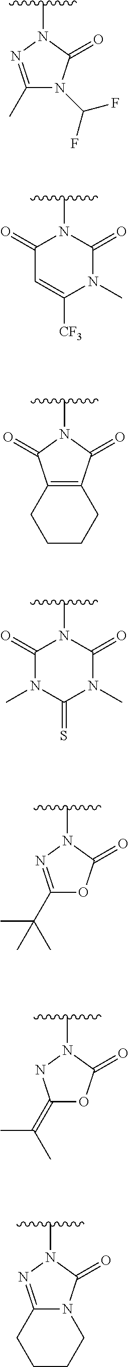

and where the other variables in formula (I) have the following meanings
X is H, F or Cl, in particular F;
Y is N or CH;
Q is Cl
R is a radical of the following formulae (1), (2), (3), (4), (5), (6), (7), (8), (9), (10) or (11):

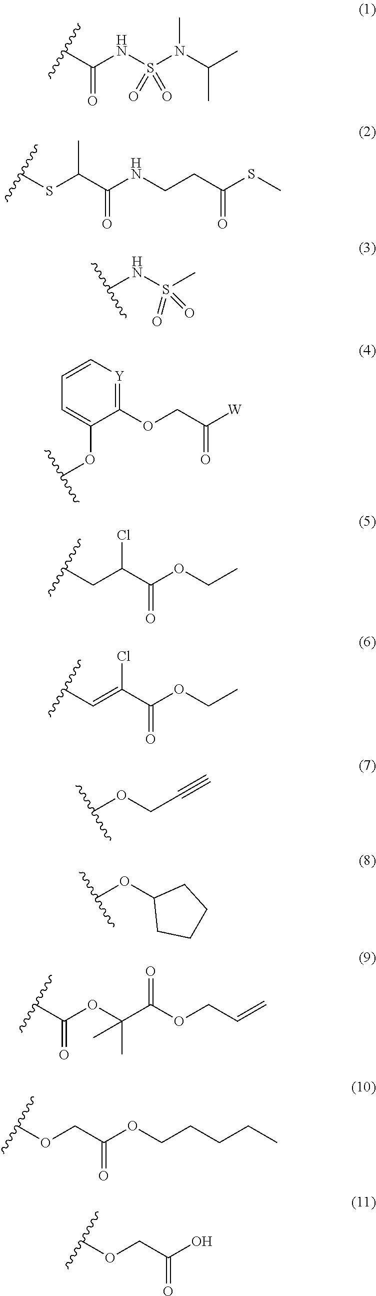

where Y in formula (4) is CH or N and W is OCH₃, OC₂H₅ or NHSO₂CH₃;
or Q and R together form one of the moieties (i), (ii)

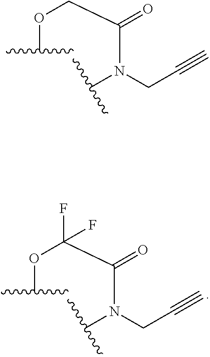

The dashed line in the groups of the formulae (a) to (g), (1) to (11), (i) and (ii) indicate the points of their attachment to the remainder of the formula (I).

Examples of compounds of the formula (I) include, for example:
azafenidin, butafenacil, carfentrazone, carfentrazone-ethyl, cinidon-ethyl, flumiclorac, flumiclorac-pentyl, flumioxazin, fluthiacet, fluthiacet-methyl, oxadiargyl, oxadiazon, pentoxazone, profluazol saflufenacil, sulfentrazone, thidiazimin, tiafenacil, trifludimoxazin, ethyl [3-[2-chloro-4-fluoro-5-(1-methyl-6-trifluoromethyl-2,4-dioxo-1,2,3,4-tetrahydropyrimidin-3-yl) phenoxy]-2-pyridyloxy]acetate (CAS 353292-31-6; S-3100), 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione (CAS 451484-50-7), 2-(2,2,7-trifluoro-3-oxo-4-prop-2-ynyl-3,4-dihydro-2Hbenzo[1,4]oxazin-6-yl)-4,5,6,7-tetrahydro-isoindole-1,3-dione (CAS 1300118-96-0), 1-methyl-6-trifluoromethyl-3-(2,2,7-trifluoro-3-oxo-4-prop-2-ynyl-3,4-dihydro-2Hbenzo[1,4]oxazin-6-yl)-1H-pyrimidine-2,4-dione (CAS 1304113-05-0), 3-[7-chloro-5-fluoro-2-(trifluoromethyl)-1H-benzimidazol-4-yl]-1-methyl-6-(trifluoromethyl)-1H-pyrimidine-2,4-dione (CAS 212754-02-4), 2-[2-[[3-chloro-6-[3,6-dihydro-3-methyl-2,6-dioxo-4-(trifluoromethyl)-1 (2H)-pyrimidinyl]-5-fluoro-2-pyridinyl]oxy]phenoxy]-acetic acid methyl ester (CAS 2158274-96-3), 2-[2-[[3-chloro-6-[3,6-dihydro-3-methyl-2,6-dioxo-4-(trifluoromethyl)-1 (2H)-pyrimidinyl]-5-fluoro-2-pyridinyl]oxy]phenoxy]acetic acid ethyl ester (CAS 2158274-50-9), methyl 2-[3-[2-chloro-5-[4-(difluoromethyl)-3-methyl-5-oxo-1,2,4-triazol-1-yl]-4-fluoro-phenoxy]-2-pyridyl]oxy]acetate (CAS 2271389-22-9), ethyl 2-[3-[2-chloro-5-[4-(difluoromethyl)-3-methyl-5-oxo-1,2,4-triazol-1-yl]-4-fluoro-phenoxy]-2-pyridyl]oxy]acetate (CAS 2230679-62-4), 2-[3-[[3-chloro-6-[3,6-dihydro-3-methyl-2,6-dioxo-4-(trifluoromethyl)-1 (2H)-pyrimidinyl]-5-fluoro-2-pyridinyl]oxy]-2-pyridinyl]oxy]-aceticacid methyl ester (CAS 2158275-73-9), 2-[[3-[[3-chloro-6-[3,6-dihydro-3-methyl-2,6-dioxo-4-(trifluoromethyl)-1 (2H)-pyrimidinyl]-5-fluoro-2-pyridinyl]oxy]-2-pyridinyl]oxy]acetic acid ethyl ester (CAS 2158274-56-5), 2-[2-[[3-chloro-6-[3,6-dihydro-3-methyl-2,6-dioxo-4-(trifluoromethyl)-1 (2H)-pyrimidinyl]-5-fluoro-2-pyridinyl]oxy]phenoxy]-N-(methylsulfonyl)-acetamide (CAS 2158274-53-2), and 2-[[3-[[3-chloro-6-[3,6-dihydro-3-methyl-2,6-dioxo-4-(trifluoromethyl)-1 (2H)-pyrimidinyl]-5-fluoro-2-pyridinyl]oxy]-2-pyridinyl]oxy]-N-(methylsulfonyl)-acetamide (CAS 2158276-22-1).

A first group of particularly preferred PPO inhibitors are those of the formula (I-a)

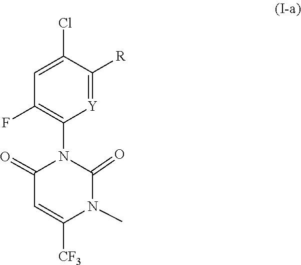

where R is a radical of the formulae (1), (2) or (4) and Y is CH or N.

Examples of compounds of the formula (I-a) include
saflufenacil, tiafenacil, ethyl [3-[2-chloro-4-fluoro-5-(1-methyl-6-trifluoromethyl-2,4-dioxo-1,2,3,4-tetrahydropyrimidin-3-yl) phenoxy]-2-pyridyloxy]acetate (CAS 353292-31-6; S-3100), 1-methyl-6-trifluoromethyl-3-(2,2,7-trifluoro-3-oxo-4-prop-2-ynyl-3,4-dihydro-2Hbenzo[1,4]oxazin-6-yl)-1H-pyrimidine-2,4-dione (CAS 1304113-05-0), 3-[7-chloro-5-fluoro-2-(trifluoromethyl)-1H-benzimidazol-4-yl]-1-methyl-6-(trifluoromethyl)-1H-pyrimidine-2,4-dione (CAS 212754-02-4), 2-[2-[3-chloro-6-[3,6-dihydro-3-methyl-2,6-dioxo-4-(trifluoromethyl)-1 (2H)-pyrimidinyl]-5-fluoro-2-pyridinyl]oxy]phenoxy]-acetic acid methyl ester (CAS 2158274-96-3), 2-[2-[[3-chloro-6-[3,6-dihydro-3-methyl-2,6-dioxo-4-(trifluoromethyl)-1 (2H)-pyrimidinyl]-5-fluoro-2-pyridinyl]oxy]phenoxy]acetic acid ethyl ester (CAS 2158274-50-9), 2-[[3-[3-chloro-6-[3,6-dihydro-3-methyl-2,6-dioxo-4-(trifluoromethyl)-1 (2H)-pyrimidinyl]-5-fluoro-2-pyridinyl]oxy]-2-pyridinyl]oxy]-aceticacid methyl ester (CAS 2158275-73-9), 2-[3-[3-chloro-6-[3,6-dihydro-3-methyl-2,6-dioxo-4-(trifluoromethyl)-1 (2H)-pyrimidinyl]-5-fluoro-2-pyridinyl]oxy]-2-pyridinyl]oxy]acetic acid ethyl ester (CAS 2158274-56-5), 2-[2-[[3-chloro-6-[3,6-dihydro-3-methyl-2,6-dioxo-4-(trifluoromethyl)-1 (2H)-pyrimidinyl]-5-fluoro-2-pyridinyl]oxy]phenoxy]-N-(methylsulfonyl)-acetamide (CAS 2158274-53-2), and 2-[3-[[3-chloro-6-[3,6-dihydro-3-methyl-2,6-dioxo-4-(trifluoromethyl)-1 (2H)-pyrimidinyl]-5-fluoro-2-pyridinyl]oxy]-2-pyridinyl]oxy]-N-(methylsulfonyl)-acetamide (CAS 2158276-22-1).

Particular preference is given to compounds of the formula (I-a) which are selected from the group consisting of saflufenacil, tiafenacil, ethyl [3-[2-chloro-4-fluoro-5-(1-methyl-6-trifluoromethyl-2,4-dioxo-1,2,3,4-tetrahydropyrimidin-3-yl) phenoxy]-2-pyridyloxy]acetate (CAS 353292-31-6; S-3100), 2-[2-[[3-chloro-6-[3,6-dihydro-3-methyl-2,6-dioxo-4-(trifluoromethyl)-1 (2H)-pyrimidinyl]-5-fluoro-2-pyridinyl]oxy]phenoxy]acetic acid ethyl ester (CAS 2158274-50-9), 2-[3-[[3-chloro-6-[3,6-dihydro-3-methyl-2,6-dioxo-4-(trifluoromethyl)-1 (2H)-pyrimidinyl]-5-fluoro-2-pyridinyl]oxy]-2-pyridinyl]oxy]-aceticacid methyl ester (CAS 2158275-73-9), 2-[[3-[[3-chloro-6-[3,6-dihydro-3-methyl-2,6-dioxo-4-(trifluoromethyl)-1 (2H)-pyrimidinyl]-5-fluoro-2-pyridinyl]oxy]-2-pyridinyl]oxy]acetic acid ethyl ester (CAS 2158274-56-5), and 2-[3-[[3-chloro-6-[3,6-dihydro-3-methyl-2,6-dioxo-4-(trifluoromethyl)-1 (2H)-pyrimidinyl]-5-fluoro-2-pyridinyl]oxy]-2-pyridinyl]oxy]-N-(methylsulfonyl)-acetamide (CAS 2158276-22-1).

A second group of particularly preferred PPO inhibitors are those of the formula (I-b)

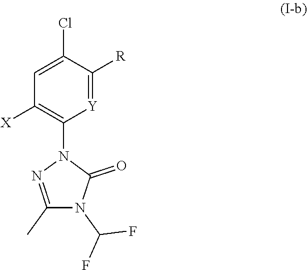

where X is F or Cl, R is a radical of the formulae (3), (4) or (5) and Y is CH or N. Examples of compounds of the formula (I-b) include carfentrazone, carfentrazone-ethyl, sulfentrazone, methyl 2-[3-[2-chloro-5-[4-(difluoromethyl)-3-methyl-5-oxo-1,2,4-triazol-1-yl]-4-fluoro-phenoxy]-2-pyridyl]oxy]acetate (CAS 2271389-22-9), ethyl 2-[3-[2-chloro-5-[4-(difluoromethyl)-3-methyl-5-oxo-1,2,4-triazol-1-yl]-4-fluoro-phenoxy]-2-pyridyl]oxy]acetate (CAS 2230679-62-4) with particular preference given to carfentrazone-ethyl, sulfentrazone, ethyl 2-[[3-[2-chloro-5-[4-(difluoromethyl)-3-methyl-5-oxo-1,2,4-triazol-1-yl]-4-fluoro-phenoxy]-2-pyridyl]oxy]acetate (CAS 2230679-62-4). A third group of particularly preferred PPO inhibitors are those of the formula (I), where

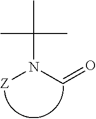

represents a radical of the formula (c), which are hereinafter referred to as compound (I-c). In compounds (I-c), X, Y, Q and R are as defined for formula (I), and X is in particular H or F, Y is in particular CH, Q is in particular C₁ and R is in particular a group (6), (10) or (11) or R and Q together form a radical (i) or (ii).

Examples of compounds of the formula (I-c) include cinidon-ethyl, flumiclorac, flumiclorac-pentyl, flumioxazin, 2-(2,2,7-trifluoro-3-oxo-4-prop-2-ynyl-3,4-dihydro-2Hbenzo[1,4]oxazin-6-yl)-4,5,6,7-tetrahydro-isoindole-1,3-dione (CAS 1300118-96-0) with particular preference given to flumioxazin.

A fourth group of particularly preferred PPO inhibitors are those of the formula (I), where

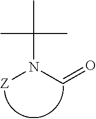

represents a radical of the formula (d), which are hereinafter referred to as compound (I-d). In compounds (I-d), X is in particular F, Y is CH or N and R and Q are as defined herein and in particular together form a radical (i) or (ii). Examples of compounds of the formula (I-c) include trifludimoxazin and 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione (CAS 451484-50-7) with particular preference given to trifludimoxazin.

The formulations of the present invention are particularly suitable for providing high loads and storage stability of the formulation in those cases where the PPO inhibitor is selected from the compounds of formulae (I-a) and (I-d), and where the PPO inhibitor herbicide of component A is especially selected from the group consisting of saflufenacil and trifludimoxazin.

Therefore, a particularly preferred group (1) of embodiments relates to the liquid formulations of the present invention, where the component A is a compound of the formula (I-a) and especially saflufenacil.

Yet, a particularly preferred group (2) of embodiments relates to the liquid formulations of the present invention, where the component A is a compound of the formula (I-d) and especially trifludimoxazin.

The concentration of the component A in the formulation of the present invention, in particular in the formulation of groups (1) and (2) of embodiments, is frequently at least 1% by weight, in particular at least 2% by weight, especially at least 4% by weight and may be as high as 30% by weight, based on the total weight of the formulation.

Preferably, the concentration of the component A in the formulation of the present invention, in particular in the formulation of groups (1) and (2) of embodiments, is in the range of 1 to 30% by weight, in particular in the range of 2 to 25% by weight, especially 4 to 25% by weight or 4 to 20% by weight or 4 to 15% by weight or 4 to 11% by weight or 7 to 15% by weight, based on the total weight of the formulation.

The liquid formulation of the invention optionally comprises at least one acid with a pKA from 1 to 6, preferably from 3 to 5, especially from 3.5 to 4.5 as a component B. The pKA value refers to the value determined at 20° C. of an 0.1 M aqueous solution of the acid in deionized water.

Frequently the component B is a mono-, di- or tricarboxylic acid having e. g. from 1 to 6 carbon atoms. Preferably, the component B is soluble in water in particular in an amount of at least 100 g/L. For example, the component B may be selected from the following groups of compounds:
C₁-C₄-alkanoic acids, such as formic acid, acetic acid and propionic acid;
C₂-C₄-alkandioic acids, such as oxalic acid, malonic acid and succinic acid;
hydroxy-C₂-C₄-alkanoic acids, such as glycolic acid and lactic acid; and
hydroxy-C₃-C₄-alkandioic acids such as malic acid.

In particular, the component B comprises or is select from C₁-C₄-alkanoic acids, in particular acetic acid.

The total amount of the component B, if present, does not exceed 5% by weight, particularly 4% by weight, especially 3% by weight, more specifically 2% by weight, even more specifically 1.5% by weight, based on the total weight of the formulation. In particular, the total amount of the component B, if present, is generally from 0.01 to 5% by weight, in particular from 0.03 to 4% by weight, preferably from 0.03 to 3% by weight, more preferably from 0.03 to 2% by weight, in particular from 0.03 to 1.5% by weight, based on the total weight of the formulation.

In a preferred embodiment, component B is present in the formulation.

In another preferred embodiment, component B is not present in the formulation.

The liquid formulation of the invention comprises a combination of the components C1-C5 as a component C. The component C is a combination of the specific emulsifiers C3 and C4 and also comprises a combination of water and organic solvents C2 and C5.

The total amount of the component C is generally at least 65% by weight, in particular at least 70% by weight, especially at least 71% by weight, based on the total weight of the formulation. Generally, the total amount of the component C is in the range of 65 to 98.99% by weight, in particular in the range of 70 to 97.97% by weight, preferably in the range of 71 to 95.97% by weight or in the range of 72 to 95.97% by weight, especially in the range of 75 to 95.97% by weight or 77 to 95.97% by weight or 83 to 92.97% by weight, based on the total weight of the formulation, if component B is present. If component B is not present, the total amount of the component C is generally in the range of 65 to 99% by weight, in particular in the range of 70 to 96% by weight, preferably in the range of 75 to 96% by weight, more preferably in the range of 80 to 96% by weight, especially in the range of 85 to 96% by weight or 85 to 93% by weight, based on the total weight of the formulation.

Preferably, if component B is present, the formulation comprises 1 to 30% by weight, based on the total weight of the formulation, of the component A, 0.01 to 5% by weight, based on the total weight of the formulation, of the component B, and 65 to 98.99% by weight, based on the total weight of the formulation, of the component C. More preferably, if component B is present, the formulation comprises 4 to 25% by weight, based on the total weight of the formulation, of the component A, 0.03 to 4% by weight, based on the total weight of the formulation, of the component B, and 71 to 95.97% by weight, based on the total weight of the formulation, of the component C. Even more preferably, if component B is present, the formulation comprises 4 to 20% by weight, based on the total weight of the formulation, of the component A, 0.03 to 3% by weight, based on the total weight of the formulation, of the component B, and 77 to 95.97% by weight, based on the total weight of the formulation, of the component C. In particular, if component B is present, the formulation comprises 4 to 15% by weight, based on the total weight of the formulation, of the component A, 0.03 to 2% by weight, based on the total weight of the formulation, of the component B, and 83 to 95.97% by weight, based on the total weight of the formulation, of the component C. Specifically, if component B is present, the formulation comprises 7 to 15% by weight, based on the total weight of the formulation, of the component A, 0.03 to 2% by weight, based on the total weight of the formulation, of the component B, and 83 to 92.97% by weight, based on the total weight of the formulation, of the component C. More specifically, if component B is present, the formulation comprises 7 to 11% by weight, based on the total weight of the formulation, of the component A, 0.03 to 1.5% by weight, based on the total weight of the formulation, of the component B, and 87.5 to 92.97% by weight, based on the total weight of the formulation, of the component C.

Preferably, if component B is not present, the formulation comprises 1 to 30% by weight, based on the total weight of the formulation, of the component A and 70 to 99% by weight, based on the total weight of the formulation, of the component C. More preferably, if component B is not present, the formulation comprises 4 to 25% by weight, based on the total weight of the formulation, of the component A and 75 to 96% by weight, based on the total weight of the formulation, of the component C. Even more preferably, if component B is not present, the formulation comprises 4 to 20% by weight, based on the total weight of the formulation, of the component A and 80 to 96% by weight, based on the total weight of the formulation, of the component C. In particular, if component B is not present, the formulation comprises 4 to 15% by weight, based on the total weight of the formulation, of the component A and 85 to 96% by weight, based on the total weight of the formulation, of the component C. Specifically, if component B is not present, the formulation comprises 4 to 11% by weight, based on the total weight of the formulation, of the component A and 89 to 96% by weight, based on the total weight of the formulation, of the component C.

The component C1 is preferably deionized water. The total amount of the component C1 is generally in the range of 0.1 to 10% by weight, preferably 0.3 to 5% by weight or 0.1 to 3% by weight or 0.1 to 2.5% by weight or 0.3 to 2.5% by weight; more preferably 0.4 to 3% by weight 0.4 to 2.5% by weight, based on the total weight of the formulation.

According to the invention, the component C comprises at least one water-miscible solvent, as the component C2. In the context of the present invention, the term “water-miscible solvent” means a solvent that can be mixed in water at a concentration of at least 50 g/l, in particular at least 100 g/l, especially at least 150 g/l, preferably at least 200 g/l at 20° C. and 1013 mbar, forming a homogeneous mixture with water. In particular, the component C2 is fully mixable with water at any ratios. Therefore, the organic solvent of the component C2 generally has a solubility in deionized water of at least at least 50 g/l, in particular at least 100 g/l, especially at least 150 g/l, preferably at least 200 g/l at 20° C. and 1013 mbar.

Generally, the component C2 is selected from the group consisting of 1-methoxy-2-propyl acetate, C₁-C₄-alkyl lactates, such as ethyl lactate or butyl lactate, C₁-C₄-alkyl lactamides, such as methyl lactamide, ethyl lactamide, propyl lactamide, isopropyl lactamide or n-butyl lactamide, di-C₁-C₂-alkyl lactamides, such as N,N-dimethyl lactamide or N,N-diethyl lactamide, N—C₁-C₄-alkyl-2-pyrrolidons, such as N-methyl-2-pyrrolidone, N-ethyl-2-pyrrolidone, N-propyl-2-pyrrolidone, N-isopropy-2-pyrrolidone or N-(n-butyl)-2-pyrrolidone, epsilon-caprolactam, C₄-C₆-lactones, such as gamma-butyrolactone or gamma-valerolactone, C₂-C₄-alkylene carbonates, such as ethylenecarbonate and propylene carbone, dimethyl sulfoxide, N,N-dimethylimidazolin-2-one and mixtures thereof.

In particular, the component C2 is selected from the group consisting of 1-methoxy-2-propyl acetate, N—C₁-C₄-alkyl-2-pyrrolidons, such as N-methyl-2-pyrrolidone, N-ethyl-2-pyrrolidone, N-propyl-2-pyrrolidone, N-isopropyl-2-pyrrolidone or N-(n-butyl)-2-pyrrolidone, epsilon-caprolactam, C₄-C₆-lactones, such as gamma-butyrolactone or gamma-valerolactone, dimethyl sulfoxide, N,N-dimethylimidazolin-2-one and mixtures thereof.

In a particularly preferred embodiment of the invention, the component C2 comprises or consists of dimethyl sulfoxide (DMSO). The component C2 may also be a mixture comprising DMSO and at least one further organic solvent C₂, which is in particular selected from the group of N—C₁-C₄-alkyl-2-pyrrolidons, such as N-methyl-2-pyrrolidone, N-ethyl-2-pyrrolidone, N-propyl-2-pyrrolidone, N-isopropyl-2-pyrrolidone or N-(n-butyl)-2-pyrrolidone, epsilon-caprolactam, C₄-C₆-lactones, such as gamma-butyrolactone or gamma-valerolactone, N,N-dimethylimidazolin-2-one. In particular, the amount of DMSO in the component C2 is at least 50% by weight, based on the total amount of the component C2. Specifically, the component C2 is dimethyl sulfoxide (DMSO).

In particular, the total amount of the component C2 is in the range of 10 to 55% by weight, preferably 20 to 50% by weight, more preferably 25 to 50% by weight, in particular 28 to 45% by weight, based on the total weight of the formulation. The total amount of the components C1 and C2 is generally at least 10% by weight, preferably at least 20% by weight, more preferably at least 30% by weight, based on the total weight of the component C. In particular, the total amount of the components C1 and C2 is in the range of 10 to 85% by weight, preferably 20 to 60% by weight, more preferably 20 to 50% by weight, based on the total weight of the component C.

In particular, the relative amount of the component C1 is in the range of 0.5 to 20% by weight, preferably in the range of 1 to 10% by weight, especially in the range of 1 to 5% by weight, based on the total weight of the components C1 and C₂ and the relative amount of the component C2 is in the range of 80 to 99.5% by weight, preferably in the range of 90 to 99% by weight, especially in the range of 95 to 99% by weight, based on the total weight of the components C1 and C₂. Preferably, the relative amount of the components C1 and C₂ may vary from 1:100 to 20:1, in particular from 1:70 to 10:1, more particularly from 1:70 to 11:1, even more particularly from 1:10 to 1:65.

The component C comprises at least one first emulsifier selected from the group consisting of C₆-C₂₅-alkanol alkoxylates, C₆-C₂₅-alkenol alkoxylates and mixtures thereof, as a component C3.

Alkanol alkoxylates and alkenol alkoxylates are typically obtained by addition reaction of alkylene oxides, in particular C₂-C₄-alkylene oxides, to C₆-C₂₅-alkanols or C₆-C₂₅-alkenols, respectively. Consequently, the alkoxylates are polyethers having oxyalkylene repeating units stemming from the alkxyleneoxide(s) used in the preparation of the respective alkoxylate.

Examples for C₂-C₄-alkylene oxides are ethylene oxide (EO), propylene oxide (PO), and butylene oxide, preference being given to ethylene oxide, propylene oxide and combinations thereof.

The C₆-C₂₅-alkanols and C₆-C₂₅-alkenols may be linear or branched. C₆-C₂₅-Alkenols may have 1, 2, 3 or 4, in particular 1 or 2 olefinically unsaturated double bounds, which may have cis or trans configuration. If the alkenol is derived from a plant oil, the C—C double bonds have generally cis configuration.

Examples of linear C₆-C₂₅-alkanols include, but are not limited to hexanol, heptanol, octanol, nonaol, decanol, undecanol, dodecanol (lauryl alcohol), tridecanol, tetradecanol myristyl alcohol), pentadecanol, hexadecanol (cetyl alcohol), heptadecanol, octadecanol (stearyl alcohol), nonadecanol, eicosanol, heneicosanol, docosanol, tricosanol, tetracosanol (lignoceryl alcohol), pentacosanol. Examples of branched C₆-C₂₅-alkanols include, but are not limited to branched alkanols such as 2-methylpentanol, 2,2-dimethylbutanol, 2-ethylbutanol, 2-ethylhexanol, 1-methylheptadecanol, 1-hexylheptanol, isodecanol and isotridecanol. Examples of linear alkenols include, but not limited to hexenol, heptenol, octenol, nonenol, decenol, undecenol, dodecenol, tridecenol, tetradecenol, pentadecenol, hexadecenol, pentadecenol, hexadecenol, heptadecenol, octadecenol (oleyl alcohol), nonadecenol, eicosenol, docosenol, tetracosenol, pentacosenol. Examples of branched alkenols include, but are not limited to isohexenol, 2-ethylhexenol, dimethyloctenol, isotridecenol, 1-methylheptadecenol, 1-hexylheptenol, isotridecenol, isophytol and isooctadecenol.

Here and throughout the specification, the terms “alkoxylated” and “polyalkoxylated” are used synonymously and refer to compounds having an oligo- or polyoxyalkylene group, which is formed by repeating units O-A, where A is alkylene, in particular C₂-C₄-alkylene. In this context, the term “degree of alkoxylation” relates to the number average of repeating units O-A in these compounds.

Preferably, the degree of alkoxylation does not exceed 10. In particular, the degree of alkoxylation of the alkanol alkoxylates is in the range of 1 to 10, preferably in the range of 2 to 7, especially in the range of 3 to 5. Likewise, in particular, the degree of alkoxylation of the alkenol alkoxylates is in the range of 1 to 10, preferably in the range of 2 to 7, especially in the range of 3 to 5.

Preference is given to C₈-C₂₀-alkanol-C₂-C₄-alkoxylates and C₈-C₂₀-alkenol-C₂-C₄-alkoxylates, in particular to C₁₀-C₁₈-alkanol-C₂-C₄-alkoxylates and C₁₀-C₁₈-alkenol-C₂-C₄-alkoxylates.

Preference is given to C₆-C₂₅-alkanol ethoxylates, C₆-C₂₅-alkenol ethoxylates, C₆-C₂₅-alkanol propoxylates, C₆-C₂₅-alkenol propoxylates, C₆-C₂₅-alkanol ethoxylate-co-propoxylates and C₆-C₂₅-alkenol ethoxylate-co-propoxylates, in particular to C₈-C₂₀-alkanol ethoxylates, C₈-C₂₀-alkenol ethoxylates, C₈-C₂₀-alkanol ethoxylate-co-propoxylates and C₈-C₂₀-alkenol ethoxylate-co-propoxylates, more particularly to C₁₀-C₁₈-alkanol ethoxylates, C₁₀-C₁₈-alkenol ethoxylates, C₁₀-C₁₈-alkanol ethoxylate-co-propoxylates and C₁₀-C₁₈-alkenol ethoxylate-co-propoxylates, especially to C₁₀-C₁₈-alkanol ethoxylates and C₁₀-C₁₈-alkenol ethoxylates.

Particular preference is given to C₆-C₂₅-alkanol ethoxylates and C₆-C₂₅-alkenol ethoxylates, more particularly to C₈-C₂₀-alkanol ethoxylates and C₈-C₂₀-alkenol ethoxylates, especially to C₁₀-C₁₈-alkanol ethoxylates and C₁₀-C₁₈-alkenol ethoxylates, wherein the degree of ethoxylation of the alkanol ethoxylates is in the range of 1 to 10, particularly in the range of 2 to 7, especially in the range of 3 to 5.

The amount of the component C3 is generally in the range of 3 to 35% by weight, preferably 4 to 30% by weight, more preferably 5 to 30% by weight, based on the total weight of the formulation.

According to the invention, the component C comprises at least one second emulsifier selected from the group consisting of polyarylphenol ethoxylates, in particular distyrylphenol ethoxylates, tristyrylphenol ethoxylates and mixtures thereof, as a component C4.

Distyrylphenol ethoxylates and tristyrylphenol ethoxylates are both ethoxylated polyarylphenols that have two phenylethenyl (=stryryl) groups and three phenylethenyl groups, respectively, connected to the benzene ring composing the phenol unit of the molecule.

Preferably, the degree of ethoxylation of the component C4 is in the range of 1 to 30, particularly in the range of 5 to 20, especially in the range of 10 to 18.

Preferably, the component C4 is selected from the group consisting of distyrylphenol ethoxylates, tristyrylphenol ethoxylates and mixtures thereof each having a degree of ethoxylation in the range of 1 to 30, particularly in the range of 5 to 20, especially in the range of 10 to 18 and mixtures thereof.

In particular, the component C4 is selected from the group consisting of tristyrylphenol ethoxylates having a degree of ethoxylation in the range of 2 to 30, particularly in the range of 5 to 20, especially in the range of 10 to 18, and mixtures thereof.

An example of ethoxylated polyarylphenol is commercially available as Soprophor® 796/p from Solvay. An example of ethoxylated tristyrylphenol is commercially available as Soprophor® S/25 or Soprophor® BSU from Solvay.

Generally, the amount of the component C4 is in the range of 3 to 30% by weight, in particular in the range of 4 to 25% by weight, especially in the range of 4 to 20% by weight, based on the total weight of the formulation.

The total amount of the components C3 and C₄ is generally in the range of 5 to 85% by weight, preferably 10 to 50% by weight, more preferably 10 to 40% by weight, based on the total weight of the component C.

In particular, the relative amount of the component C3 is in the range of 30 to 90% by weight, preferably in the range of 35 to 90% by weight, especially in the range of 40 to 90% by weight, based on the total weight of the components C3 and C₄ and the relative amount of the component C4 is in the range of 10 to 70% by weight, preferably in the range of 10 to 65% by weight, especially in the range of 10 to 60% by weight, based on the total weight of the components C3 and C₄. Preferably, the relative amount of the components C3 and C₄ may vary from 1:5 to 10:1, in particular from 1:2 to 10:1, more particularly from 1:1.5 to 7:1.

The liquid formulation of the invention further contains at least one C₆-C₂₀-fatty acid-C₁-C₄-alkyl ester, in particular a C₆-C₂₀-fatty acid methyl ester or a C₆-C₂₀-fatty acid ethyl ester, as a component C5.

In a particular embodiment, component C5 comprises at least one C₁₈-fatty acid-C₁-C₄-alkyl ester, in particular a C₁₈-fatty acid methyl ester or a C₁₈-fatty acid ethyl ester.

In this particular embodiment, the component C5 comprises at least 60% by weight, preferably at least 70% by weight, particularly at least 80% by weight, based on the total weight of the component C5, of the at least one C₁₈-fatty acid-C₁-C₄-alkyl ester.

It has been found beneficial if the component C5 comprises
not more than 21% by weight, based on the total weight of the component C5), of at least one C₁₀-C₁₇-fatty acid-C₁-C₄-alkyl ester,
not more than 2% by weight, based on the total weight of the component C5), of at least one C₁₉-C₂₀-fatty acid-C₁-C₄-alkyl ester,
not more than 8% by weight, based on the total weight of the component C5), of C₁-C₄-alkyl palmitate, and
not more than 4% by weight, based on the total weight of the component C5), of C₁-C₄-alkyl stearate.

In particular, the component C5 comprises
not more than 21% by weight, based on the total weight of the component C5), of at least one C₁₀-C₁₇-fatty acid-C₁-C₄-alkyl ester,
not more than 2% by weight, based on the total weight of the component C5), of at least one C₁₉-C₂₀-fatty acid-C₁-C₄-alkyl ester,
not more than 8% by weight, based on the total weight of the component C5), of methyl palmitate, and
not more than 4% by weight, based on the total weight of the component C5), of methyl stearate.

Examples of C₁-C₄-alkyl esters of C₆-C₂₀-fatty acids include, but not limited to methylester, ethylester, propylester and butylester with particular preference given to methyl esters and ethyl esters.

Here, the C₆-C₂₀-fatty acid of the C₆-C₂₀-fatty acid-C₁-C₄-alkyl ester may be saturated or unsaturated. Here, the C₆-C₂₀-fatty acid of the C₆-C₂₀-fatty acid-C₁-C₄-alkyl ester may be a single fatty acid or a mixture of fatty acids. Fatty acid alkyl esters are prepared by any one of the well-known methods, for example, by the transesterification of vegetable fats and oils.

Examples of C₆-C₂₀-fatty acids include, but are not limited to, caproic acid, enanthic acid, caprylic acid, pelargonic acid, capric acid, lauric acid, myristic acid, palmitic acid, stearic acid, oleic acid, linoleic acid, linolenic acid, arachidonic acid and eicosapentaenoic acid and mixtures thereof. Examples of C₁₈-fatty acid-C₁-C₄-alkyl esters include, but not limited to methyl, ethyl, propyl and butyl esters of stearic acid, oleic acid, linoleic acid and linolenic acid.

In a preferred embodiment of the invention, the component C5 is a methylated plant oil or a mixture of methylated plant oils, in particular selected from the group consisting of methylated rapeseed oil, methylated sunflower oil, methylated soybean oil, methylated peanut oil, methylated olive oil, methylated corn oil, methylated grape seed oil, methylated safflower oil, methylated sesame oil, methylated buriti oil, methylated canola oil, and methylated hemp seed oil.

In the particular embodiment, where the component C5 comprises at least one C₁₈-fatty acid-C₁-C₄-alkyl ester, in particular a C₁₈-fatty acid methyl ester or a C₁₈-fatty acid ethyl ester, the weight ratio of at least one C₁₈-fatty acid-C₁-C₄-alkyl ester to the other components constituting the component C5 is preferably in the range of 4:1 to 3:2, particularly in the range of 3:1 to 2.5:1.

In this particular embodiment, the weight ratio of at least one C₁₀-C₁₇-fatty acid-C₁-C₄-alkyl ester to at least one C₁₉-C₂₀-fatty acid-C₁-C₄-alkyl ester to methyl palmitate to methyl stearate is in the range of 5.25:0.5:2:1 to 1:2.5:0.4:0.2, particularly in the range of 4:0.6:1.5:1 to 2:2:0.5:0.5.

In another particular embodiment, component C5 comprises or consists of a C₆-C₁₀-fatty acid C₁-C₄-alkyl ester, preference being given to the methyl ester; preferably a saturated C₆-C₁₀-fatty acid C₁-C₄-alkyl ester, preference being given to the methyl ester; more preferably a saturated C₈-C₁₀-fatty acid C₁-C₄-alkyl ester, preference being given to the methyl ester.

The total amount of the component C5 is generally in the range of 5 to 80% by weight, preferably 10 to 60% by weight, more preferably 20 to 40% by weight, based on the total weight of the component C.

In particular, the component C comprises
10 to 85% by weight, preferably 20 to 60% by weight, more preferably 20 to 50% by weight, based on the total weight of the component C), of the components C1) and C₂),
5 to 85% by weight, preferably 10 to 50% by weight, more preferably 10 to 40% by weight, based on the total weight of the component C), of the components C3) and C4),
5 to 80% by weight, preferably 10 to 60% by weight, more preferably 20 to 40% by weight, based on the total weight of the component C), of the component C5).

More particularly, the component C comprises
0.1 to 10% by weight, preferably 0.3 to 5% by weight, more preferably 0.4 to 3% by weight, based on the total weight of the component C, of the component C1,
10 to 55% by weight, preferably 20 to 50% by weight, more preferably 20 to 45% by weight, based on the total weight of the component C, of the component C2,
3 to 35% by weight, preferably 4 to 30% by weight, more preferably 5 to 30% by weight, based on the total weight of the component C, of the component C3,
3 to 30% by weight, preferably 4 to 25% by weight, more preferably 4 to 20% by weight, based on the total weight of the component C, of the component C4,
5 to 80% by weight, preferably 10 to 60% by weight, more preferably 20 to 40% by weight, based on the total weight of the component C, of the component C5.

In particular, the liquid formulation according to the invention comprises
a) at least one of saflufenacil and trifludimoxazin, as a component A),
b) optionally at least one C₁-C₄-alkanoic acid, in particular acetic acid, as a component B), and
c) a solvent-emulsifier combination, as a component C), comprising
   c1) water, as a component C1),
   c2) at least one water-miscible solvent, as a component C2), selected from the group consisting of 1-methoxy-2-propyl acetate, C₁-C₄-alkyl lactates, such as ethyl lactate or butyl lactate, C₁-C₄ alkyl lactamides, such as methyl lactamide, ethyl lactamide, propyl lactamide, isopropyl lactamide or n-butyl lactamide, di-C₁-C₂-alkyl lactamides, such as N,N-dimethyl lactamide or N,N-diethyl lactamide, N—C₁-C₄-alkyl-2-pyrrolidons, such as N-methyl-2-pyrrolidone, N-ethyl-2-pyrrolidone, N-propyl-2-pyrrolidone, N-(n-butyl)-2-pyrrolidone, N-(n-butyl)-2-pyrrolidone, epsilon-caprolactam, C₄-C₆-lactones, such as gamma-butyrolactone or gamma-valerolactone, C₂-C₄-alkylene carbonates, such as ethylenecarbonate and propylene carbone, dimethyl sulfoxide, N,N-dimethylimidazolin-2-one and mixtures thereof;
   c3) at least one first emulsifier, as a component C3), selected from the group consisting of C₆-C₂₅-alkanol alkoxylates, C₆-C₂₅-alkenol alkoxylates mixtures thereof, in particular selected from the group consisting of C₈-C₂₀-alkanol-C₂-C₄-alkoxylates and C₈-C₂₀-alkenol-C₂-C₄-alkoxylates and mixtures thereof, especially C₁₀-C₁₈-alkanol-C₂-C₄-alkoxylates and C₁₀-C₁₈-alkenol-C₂-C₄-alkoxylates,
   c4) at least one second emulsifier, as a component C4), selected from the group consisting of distyrylphenol ethoxylate, tristyrylphenol ethoxylate and mixtures thereof, wherein the degree of ethoxylation of the component C4 is in the range of 1 to 30, particularly in the range of 5 to 20, especially in the range of 10 to 18; and
   c5) at least one C₁₀-C₂₀-fatty acid-C₁-C₄-alkyl ester, as a component C5), comprising at least one C₁₈-fatty acid-C₁-C₄-alkyl ester, where the component C5) is selected from the group consisting of methylated rapeseed oil, methylated sunflower oil, methylated soybean oil, methylated peanut oil, methylated olive oil, methylated corn oil, methylated grape seed oil, methylated safflower oil, methylated sesame oil, methylated buriti oil, methylated canola oil, and methylated hemp seed oil;
      or
      at least one saturated C₆-C₁₀-fatty acid methyl ester as a component C5).

Especially, the liquid formulation according to the invention comprises
a) at least one of saflufenacil and trifludimoxazin, as a component A),
b) optionally at least one C₁-C₄-alkanoic acid, in particular acetic acid, as a component B), and
c) a solvent-emulsifier combination, as a component C), comprising
   c1) water, as a component C1),
   c2) at least one water-miscible solvent, as a component C2), selected from the group consisting of 1-methoxy-2-propyl acetate, N—C₁-C₄-alkyl-2-pyrrolidons, such as N-methyl-2-pyrrolidone, N-ethyl-2-pyrrolidone, N-propyl-2-pyrrolidone, N-(n-butyl)-2-pyrrolidone, N-(n-butyl)-2-pyrrolidone, epsilon-caprolactam, C₄-C₆-lactones, such as gamma-butyrolactone or gamma-valerolactone, dimethyl sulfoxide, N,N-dimethylimidazolin-2-one and mixtures thereof;
   c3) at least one first emulsifier, as a component C3), selected from the group consisting of C₆-C₂₅-alkanol ethoxylates and C₆-C₂₅-alkenol ethoxylates, more particularly from C₈-C₂₀-alkanol ethoxylates and C₈-C₂₀-alkenol ethoxylates, especially from C₁₀-C₁₈-alkanol ethoxylates and C₁₀-C₁₈-alkenol ethoxylates,
   c4) at least one second emulsifier, as a component C4), selected from the group consisting of distyrylphenol ethoxylate, tristyrylphenol ethoxylate and mixtures thereof, wherein the degree of ethoxylation of the component C4 is in the range of 1 to 30, particularly in the range of 5 to 20, especially in the range of 10 to 18; and
   c5) at least one C₁₀-C₂₀-fatty acid-C₁-C₄-alkyl ester, as a component C5), comprising at least one C₁₈-fatty acid-C₁-C₄-alkyl ester, selected from the group consisting of methylated rapeseed oil, methylated sunflower oil, methylated soybean oil, methylated peanut oil, methylated olive oil, methylated corn oil, methylated grape seed oil, methylated safflower oil, methylated sesame oil, methylated buriti oil, methylated canola oil, and methylated hemp seed oil, where the component C5 in particular comprises
      not more than 21% by weight, based on the total weight of the component C5), of at least one C₁₀-C₁₇-fatty acid-C₁-C₄-alkyl ester,
      not more than 2% by weight, based on the total weight of the component C5), of at least one C₁₉-C₂₀-fatty acid-C₁-C₄-alkyl ester,
      not more than 8% by weight, based on the total weight of the component C5), of methyl palmitate, and
      not more than 4% by weight, based on the total weight of the component C5), of methyl stearate;
   or
   at least one saturated C₆-C₁₀-fatty acid methyl ester as a component C5), which preferably comprises a saturated C₈-fatty acid methyl ester.

In particular, the formulation of the present invention comprises
1 to 30% by weight, in particular 2 to 25% by weight, especially 4 to 25% by weight or 4 to 20% by weight or 4 to 15% by weight or 4 to 11% by weight or 7 to 15% by weight, based on the total weight of the formulation, of the component A,
0 to 5% by weight, preferably 0 to 4% by weight, especially 0 to 3% by weight or 0 to 2% by weight or 0 to 1.5% by weight, based on the total weight of the formulation, of the component B, and
65 to 99% by weight, in particular 71 to 98% by weight, preferably 72 to 96% by weight, especially 78 to 96% by weight or 83 to 96% by weight or 87.5 to 96% by weight or 83 to 93% by weight of the component C, based on the total weight of the formulation.

Preferably, the formulation of the present invention comprises
a) 1 to 30% by weight, in particular 2 to 25% by weight, especially 4 to 25% by weight or 4 to 20% by weight or 4 to 15% by weight or 4 to 11% by weight or 7 to 15% by weight, based on the total weight of the formulation, of the component A,
b) 0 to 5% by weight, preferably 0 to 4% by weight, particularly 0 to 3% by weight or 0 to 2% by weight or 0 to 1.5% by weight, based on the total weight of the formulation, of the component B, and
c) 65 to 99% by weight, in particular 71 to 98% by weight or 72 to 96% by weight, especially 78 to 96% by weight or 83 to 96% by weight or 87.5 to 96% by weight or 83 to 93% by weight, based on the total weight of the formulation, of a solvent-emulsifier combination, as a component C), comprising
   10 to 85% by weight, in particular 20 to 60% by weight, especially 20 to 50% by weight, based on the total weight of the component C), of water, as a component C1) and at least one water-miscible solvent, as a component C2),
   3 to 35% by weight, in particular 4 to 30% by weight, especially 5 to 30% by weight, based on the total weight of the component C), of at least one first emulsifier, as a component C3), selected from the group consisting of C₆-C₂₅-alkanol alkoxylates, C₆-C₂₅-alkenol alkoxylates mixtures thereof,
   3 to 30% by weight, in particular 4 to 25% by weight, especially 4 to 20% by weight, based on the total weight of the component C), of at least one second emulsifier, as a component C4), selected from the group consisting of distyrylphenol ethoxylate, tristyrylphenol ethoxylate and mixtures thereof, and
   5 to 80% by weight, in particular 10 to 60% by weight, especially 20 to 40% by weight, based on the total weight of the component C), of at least one C₁₀-C₂₀-fatty acid-C₁-C₄-alkyl ester, as a component C5), comprising at least one C₁₈-fatty acid-C₁-C₄-alkyl ester

Preferably, the formulation of the present invention may also comprise
a) 1 to 30% by weight, in particular 2 to 25% by weight, especially 4 to 25% by weight or 4 to 20% by weight or 4 to 15% by weight or 4 to 11% by weight or 7 to 15% by weight, based on the total weight of the formulation, of the component A,
b) 0 to 5% by weight, preferably 0 to 4% by weight, particularly 0 to 3% by weight or 0 to 2% by weight or 0 to 1.5% by weight, based on the total weight of the formulation, of the component B, and
c) 65 to 99% by weight, in particular 71 to 98% by weight or 72 to 96% by weight, especially 78 to 96% by weight or 83 to 96% by weight or 87.5 to 96% by weight or 83 to 93% by weight, based on the total weight of the formulation, of a solvent-emulsifier combination, as a component C), comprising
   10 to 85% by weight, in particular 20 to 60% by weight, especially 20 to 50% by weight, based on the total weight of the component C), of water, as a component C1) and at least one water-miscible solvent, as a component C2),
   3 to 35% by weight, in particular 4 to 30% by weight, especially 5 to 30% by weight, based on the total weight of the component C), of at least one first emulsifier, as a component C3), selected from the group consisting of C₆-C₂₅-alkanol alkoxylates, C₆-C₂₅-alkenol alkoxylates mixtures thereof,
   3 to 30% by weight, in particular 4 to 25% by weight, especially 4 to 20% by weight, based on the total weight of the component C), of at least one second emulsifier, as a component C4), selected from the group consisting of distyrylphenol ethoxylate, tristyrylphenol ethoxylate and mixtures thereof, and
   5 to 80% by weight, in particular 10 to 60% by weight, especially 20 to 40% by weight, based on the total weight of the component C), of at least one saturated C₆-C₁₀-fatty acid-C₁-C₄-alkyl ester, in particular at least one saturated C₆-C₁₀-fatty acid methyl or ethyl ester.

More preferably, the formulation of the present invention comprises
a) 1 to 30% by weight, in particular 2 to 25% by weight, especially 4 to 25% by weight or 4 to 20% by weight or 4 to 15% by weight or 4 to 11% by weight or 7 to 15% by weight, based on the total weight of the formulation, of the component A which is selected from saflufenacil and trifludimoxazin and combinations thereof,
b) 0 to 5% by weight, preferably 0 to 4% by weight, particularly 0 to 3% by weight or 0 to 2% by weight or 0 to 1.5% by weight, based on the total weight of the formulation, of the component B, which is at least one C₁-C₄-alkanoic acid, in particular acetic acid, and
c) 65 to 99% by weight, in particular 71 to 98% by weight or 72 to 96% by weight, especially 78 to 96% by weight or 83 to 96% by weight or 87.5 to 96% by weight or 83 to 93% by weight, based on the total weight of the formulation, of a solvent-emulsifier combination, as a component C), comprising
   10 to 85% by weight, in particular 20 to 60% by weight, especially 20 to 50% by weight, based on the total weight of the component C), of water, as a component C1) and at least one water-miscible solvent, as a component C2), which is selected from the group consisting of 1-methoxy-2-propyl acetate, C₁-C₄-alkyl lactates, such as ethyl lactate or butyl lactate, C₁-C₄ alkyl lactamides, such as methyl lactamide, ethyl lactamide, propyl lactamide, isopropyl lactamide or n-butyl lactamide, di-C₁-C₂-alkyl lactamides, such as N,N-dimethyl lactamide or N,N-diethyl lactamide, N—C₁-C₄-alkyl-2-pyrrolidons, such as N-methyl-2-pyrrolidone, N-ethyl-2-pyrrolidone, N-propyl-2-pyrrolidone, N-(n-butyl)-2-pyrrolidone, N-(n-butyl)-2-pyrrolidone, epsilon-caprolactam, C₄-C₆-lactones, such as gamma-butyrolactone or gamma-valerolactone, C₂-C₄-alkylene carbonates, such as ethylenecarbonate and propylene carbone, dimethyl sulfoxide, N,N-dimethylimidazolin-2-one and mixtures thereof,
   3 to 35% by weight, in particular 4 to 30% by weight, especially 5 to 30% by weight, based on the total weight of the component C), of at least one first emulsifier, as a component C3), which is selected from the group consisting of C₈-C₂₀-alkanol-C₂-C₄-alkoxylates and C₈-C₂₀-alkenol-C₂-C₄-alkoxylates and mixtures thereof, especially C₁₀-C₁₈-alkanol-C₂-C₄-alkoxylates and C₁₃-C₁₀-alkenol-C₂-C₄-alkoxylates,
   3 to 30% by weight, in particular 4 to 25% by weight, especially 4 to 20% by weight, based on the total weight of the component C), of at least one second emulsifier, as a component C4), selected from the group consisting of distyrylphenol ethoxylate, tristyrylphenol ethoxylate and mixtures thereof, wherein the degree of ethoxylation of the component C4 is in the range of 1 to 30, particularly in the range of 5 to 20, especially in the range of 10 to 18, and
   5 to 80% by weight, in particular 10 to 60% by weight, especially 20 to 40% by weight, based on the total weight of the component C), of at least one C₁₀-C₂₀-fatty acid-C₁-C₄-alkyl ester, as a component C5), comprising at least one C₁₈-fatty acid-C₁-C₄-alkyl ester, where the component C5) is selected from the group consisting of methylated rapeseed oil, methylated sunflower oil, methylated soybean oil, methylated peanut oil, methylated olive oil, methylated corn oil, methylated grape seed oil, methylated safflower oil, methylated sesame oil, methylated buriti oil, methylated canola oil, and methylated hemp seed oil.

More preferably, the formulation of the present invention may also comprise
a) 1 to 30% by weight, in particular 2 to 25% by weight, especially 4 to 25% by weight or 4 to 20% by weight or 4 to 15% by weight or 4 to 11% by weight or 7 to 15% by weight, based on the total weight of the formulation, of the component A which is selected from saflufenacil and trifludimoxazin and combinations thereof,
b) 0 to 5% by weight, preferably 0 to 4% by weight, particularly 0 to 3% by weight or b) 0 to 2% by weight or 0 to 1.5% by weight, based on the total weight of the formulation, of the component B, which is at least one C₁-C₄-alkanoic acid, in particular acetic acid, and
c) 65 to 99% by weight, in particular 71 to 98% by weight or 72 to 96% by weight, especially 78 to 96% by weight or 83 to 96% by weight or 87.5 to 96% by weight or 83 to 93% by weight, based on the total weight of the formulation, of a solvent-emulsifier combination, as a component C), comprising
   10 to 85% by weight, in particular 20 to 60% by weight, especially 20 to 50% by weight, based on the total weight of the component C), of water, as a component C1) and at least one water-miscible solvent, as a component C2), which is selected from the group consisting of 1-methoxy-2-propyl acetate, C₁-C₄-alkyl lactates, such as ethyl lactate or butyl lactate, C₁-C₄ alkyl lactamides, such as methyl lactamide, ethyl lactamide, propyl lactamide, isopropyl lactamide or n-butyl lactamide, di-C₁-C₂-alkyl lactamides, such as N,N-dimethyl lactamide or N,N-diethyl lactamide, N—C₁-C₄-alkyl-2-pyrrolidons, such as N-methyl-2-pyrrolidone, N-ethyl-2-pyrrolidone, N-propyl-2-pyrrolidone, N-(n-butyl)-2-pyrrolidone, N-(n-butyl)-2-pyrrolidone, epsilon-caprolactam, C₄-C₆-lactones, such as gamma-butyrolactone or gamma-valerolactone, C₂-C₄-alkylene carbonates, such as ethylenecarbonate and propylene carbone, dimethyl sulfoxide, N,N-dimethylimidazolin-2-one and mixtures thereof,
   3 to 35% by weight, in particular 4 to 30% by weight, especially 5 to 30% by weight, based on the total weight of the component C), of at least one first emulsifier, as a component C3), which is selected from the group consisting of C₈-C₂₀-alkanol-C₂-C₄-alkoxylates and C₈-C₂₀-alkenol-C₂-C₄-alkoxylates and mixtures thereof, especially C₁₀-C₁₈-alkanol-C₂-C₄-alkoxylates and C₁₃-C₁₀-alkenol-C₂-C₄-alkoxylates,
   3 to 30% by weight, in particular 4 to 25% by weight, especially 4 to 20% by weight, based on the total weight of the component C), of at least one second emulsifier, as a component C4), selected from the group consisting of distyrylphenol ethoxylate, tristyrylphenol ethoxylate and mixtures thereof, wherein the degree of ethoxylation of the component C4 is in the range of 1 to 30, particularly in the range of 5 to 20, especially in the range of 10 to 18, and
   5 to 80% by weight, in particular 10 to 60% by weight, especially 20 to 40% by weight, based on the total weight of the component C), of at least one C₆-C₁₀-fatty acid-C₁-C₄-alkyl ester, in particular of at least one of at least one C₆-C₁₀-fatty acid methyl or ethyl ester, as a component C5), comprising at least one C₈-fatty acid-C₁-C₄-alkyl ester, in particular at least one C₈-fatty acid methyl or ethyl ester.

Especially, the formulation of the present invention comprises
a) 1 to 30% by weight, in particular 2 to 25% by weight, especially 4 to 25% by weight or 4 to 20% by weight or 4 to 15% by weight or 4 to 11% by weight or 7 to 15% by weight, based on the total weight of the formulation, of the component A which is selected from saflufenacil and trifludimoxazin and combinations thereof,
b) 0 to 5% by weight, preferably 0 to 4% by weight, particularly 0 to 3% by weight or 0 to 2% by weight or 0 to 1.5% by weight, based on the total weight of the formulation, of the component B, which is at least one C₁-C₄-alkanoic acid, in particular acetic acid, and
c) 65 to 99% by weight, in particular 71 to 98% by weight or 72 to 96% by weight, especially 78 to 96% by weight or 83 to 96% by weight or 87.5 to 96% by weight or 83 to 93% by weight, based on the total weight of the formulation, of a solvent-emulsifier combination, as a component C), comprising
   10 to 85% by weight, in particular 20 to 60% by weight, especially 20 to 50% by weight, based on the total weight of the component C), of water, as a component C1) and at least one water-miscible solvent, as a component C2), which is selected from the group consisting of 1-methoxy-2-propyl acetate, N—C₁-C₄-alkyl-2-pyrrolidons, such as N-methyl-2-pyrrolidone, N-ethyl-2-pyrrolidone, N-propyl-2-pyrrolidone, N-(n-butyl)-2-pyrrolidone, N-(n-butyl)-2-pyrrolidone, epsilon-caprolactam, C₄-C₆-lactones, such as gamma-butyrolactone or gamma-valerolactone, dimethyl sulfoxide, N,N-dimethylimidazolin-2-one and mixtures thereof,
   3 to 35% by weight, in particular 4 to 30% by weight, especially 5 to 30% by weight, based on the total weight of the component C), of at least one first emulsifier, as a component C3), which is selected from the group consisting of C₆-C₂₅-alkanol ethoxylates and C₆-C₂₅-alkenol ethoxylates, more particularly from C₈-C₂₀-alkanol ethoxylates and C₈-C₂₀-alkenol ethoxylates, especially from C₁₀-C₁₈-alkanol ethoxylates and C₁₀-C₁₈-alkenol ethoxylates,
   3 to 30% by weight, in particular 4 to 25% by weight, especially 4 to 20% by weight, based on the total weight of the component C), of at least one second emulsifier, as a component C4), selected from the group consisting of distyrylphenol ethoxylate, tristyrylphenol ethoxylate and mixtures thereof, wherein the degree of ethoxylation of the component C4 is in the range of 1 to 30, particularly in the range of 5 to 20, especially in the range of 10 to 18, and
   5 to 80% by weight, in particular 10 to 60% by weight, especially 20 to 40% by weight, based on the total weight of the component C), of at least one C₆-C₂₀-fatty acid-C₁-C₄-alkyl ester, as a component C5), comprising at least one C₁₈-fatty acid-C₁-C₄-alkyl ester, where the component C5) is selected from the group consisting of methylated rapeseed oil, methylated sunflower oil, methylated soybean oil, methylated peanut oil, methylated olive oil, methylated corn oil, methylated grape seed oil, methylated safflower oil, methylated sesame oil, methylated buriti oil, methylated canola oil, and methylated hemp seed oil,
   where the component C5 in particular comprises
      not more than 21% by weight, based on the total weight of the component C5), of at least one C₁₀-C₁₇-fatty acid-C₁-C₄-alkyl ester,
      not more than 2% by weight, based on the total weight of the component C5), of at least one C₁₉-C₂₀-fatty acid-C₁-C₄-alkyl ester,
      not more than 8% by weight, based on the total weight of the component C5), of methyl palmitate, and
      not more than 4% by weight, based on the total weight of the component C5), of methyl stearate.

Especially, the formulation of the present invention may also comprise
a) 1 to 30% by weight, in particular 2 to 25% by weight, especially 4 to 25% by weight or 4 to 20% by weight or 4 to 15% by weight or 4 to 11% by weight or 7 to 15% by weight, based on the total weight of the formulation, of the component A which is selected from saflufenacil and trifludimoxazin and combinations thereof, 0 to 5% by weight, preferably 0 to 4% by weight, particularly 0 to 3% by weight or
b) 0 to 2% by weight or 0 to 1.5% by weight, based on the total weight of the formulation, of the component B, which is at least one C₁-C₄-alkanoic acid, in particular acetic acid, and
c) 65 to 99% by weight, in particular 71 to 98% by weight or 72 to 96% by weight, especially 78 to 96% by weight or 83 to 96% by weight or 87.5 to 96% by weight or 83 to 93% by weight, based on the total weight of the formulation, of a solvent-emulsifier combination, as a component C), comprising
   10 to 85% by weight, in particular 20 to 60% by weight, especially 20 to 50% by weight, based on the total weight of the component C), of water, as a component C1) and at least one water-miscible solvent, as a component C2), which is selected from the group consisting of 1-methoxy-2-propyl acetate, N—C₁-C₄-alkyl-2-pyrrolidons, such as N-methyl-2-pyrrolidone, N-ethyl-2-pyrrolidone, N-propyl-2-pyrrolidone, N-(n-butyl)-2-pyrrolidone, N-(n-butyl)-2-pyrrolidone, epsilon-caprolactam, C₄-C₆-lactones, such as gamma-butyrolactone or gamma-valerolactone, dimethyl sulfoxide, N,N-dimethylimidazolin-2-one and mixtures thereof,
   3 to 35% by weight, in particular 4 to 30% by weight, especially 5 to 30% by weight, based on the total weight of the component C), of at least one first emulsifier, as a component C3), which is selected from the group consisting of C₆-C₂₅-alkanol ethoxylates and C₆-C₂₅-alkenol ethoxylates, more particularly from C₈-C₂₀-alkanol ethoxylates and C₈-C₂₀-alkenol ethoxylates, especially from C₁₀-C₁₈-alkanol ethoxylates and C₁₀-C₁₈-alkenol ethoxylates,
   3 to 30% by weight, in particular 4 to 25% by weight, especially 4 to 20% by weight, based on the total weight of the component C), of at least one second emulsifier, as a component C4), selected from the group consisting of distyrylphenol ethoxylate, tristyrylphenol ethoxylate and mixtures thereof, wherein the degree of ethoxylation of the component C4 is in the range of 1 to 30, particularly in the range of 5 to 20, especially in the range of 10 to 18, and
   5 to 80% by weight, in particular 10 to 60% by weight, especially 20 to 40% by weight, based on the total weight of the component C), of at least one C₆-C₁₀-fatty acid-C₁-C₄-alkyl ester, as a component C5), comprising at least one C₈-fatty acid-C₁-C₄-alkyl ester in an amount of at least 50% by weight.

In a specific embodiment, the formulation comprises:
4 to 11% by weight, based on the total weight of the formulation, of saflufenacil (component A);
0 to 1.5% by weight, based on the total weight of the formulation, of acetic acid (component B);
0.1 to 2.5% by weight, based on the total weight of the formulation, of water (component C1);
25 to 50% by weight, preferably 28 to 45% by weight, based on the total weight of the formulation, of DMSO (component C2);
5 to 30% by weight, based on the total weight of the formulation, of one or more alcohol ethoxylates selected from C₁₀-C₁₈-alkanol ethoxylates, C₁₀-C₁₈-alkenol ethoxylates and mixtures thereof, wherein the degree of ethoxylation of the alkanol ethoxylates and alkenol ethoxylates is in the range of 1 to 10, preferably in the range of 2 to 10, e.g. 3 to 10; in particular in the range of 2 to 7, especially in the range of 3 to 5 (component C3);
4-20% by weight of distyrylphenol ethoxylates, tristyrylphenol ethoxylates or mixtures thereof, each having a degree of ethoxylation in the range of 1 to 30, particularly in the range of 5 to 20, especially in the range of 10 to 18; preferably 4-20% by weight of tristyrylphenol ethoxylates having a degree of ethoxylation in the range of 1 to 30, particularly in the range of 5 to 20, especially in the range of 10 to 18 (component C4); and
20 to 35% by weight of a methylated plant oil, preferably selected from methylated rapeseed oil, methylated sunflower oil, methylated soybean oil, methylated peanut oil, methylated olive oil, methylated corn oil, methylated grape seed oil, methylated safflower oil, methylated sesame oil, methylated buriti oil, methylated canola oil, methylated hemp seed oil, and mixtures thereof; or of at least one saturated C₆-C₁₀-fatty acid methyl ester, preferably comprising methyl caprylate in an amount of at least 50% by weight of all C₆-C₁₀-fatty acid methyl esters (component C5).

More specifically, the formulation comprises:
4 to 11% by weight, based on the total weight of the formulation, of saflufenacil (component A);
0 to 1.5% by weight, based on the total weight of the formulation, of acetic acid (component B);
0.1 to 2.5% by weight, based on the total weight of the formulation, of water (component C1);
28 to 45% by weight, based on the total weight of the formulation, of DMSO (component C2);
5 to 30% by weight, based on the total weight of the formulation, of one or more alcohol ethoxylates selected from C₁₀-C₁₈-alkanol ethoxylates, C₁₀-C₁₈-alkenol ethoxylates and mixtures thereof, wherein the degree of ethoxylation of the alkanol ethoxylates and alkenol ethoxylates is in the range of 1 to 10, preferably in the range of 2 to 10, e.g. 3 to 10; in particular in the range of 2 to 7, especially in the range of 3 to 5 (component C3);
4-20% by weight of tristyrylphenol ethoxylates having a degree of ethoxylation in the range of 10 to 18 (component C4); and
20 to 35% by weight of methylated rapeseed oil or of methyl caprylate, preferably 20 to 30% by weight of methylated rapeseed oil.

The liquid formulation according to the present invention can also comprise a water-soluble agrochemical active as a component D, especially in form of a salt. One of preferred water soluble agrochemical actives is a water-soluble herbicide.

More preferably, the water-soluble agrochemical active to be used in the liquid formulation according to the present invention is a water-soluble herbicide selected from glufosinate or its salts, dicamba or its salts, glyphosate or its salts or any derivatives of the imidazolinone herbicides or their salts.

In a preferred embodiment, the actives and/or active salts which are suitable to be formulated in the liquid phase of the liquid formulation according to the present invention are glufosinate salts, in particular glufosinate ammonium, and especially the L-enantiomer salts, such as L-glufosinate-ammonium. Suitable salts of glyphosate are for example glyphosate-ammonium, glyphosate-diammonium, glyphoste-dimethylammonium, glyphosate-isopropylammonium, glyphosate-potassium, glypho-sate-sodium, glyphosate-trimesium as well as the ethanolamine and diethanolamine salts, preferably glyphosate-diammonium, glyphosate-isopropylammonium and glyphosate-trimesium (sulfosate).

Besides the aforementioned components A, B, C and D, the formulations of the present invention may contain conventional additives which may be usually contained in liquid formulations of organic pesticide compounds. These additives include, but are not limited to, anti-foam agents, dyes, pigments and preservatives to prevent microbial spoiling. The total amount of these additives will generally not exceed 5% by weight.

Antifoam agents suitable for the formulations according to the invention are, for example, silicone emulsions (such as, for example, Silicone SRE-PFL from Wacker or Rhodorsil® from Bluestar Silicones), long-chain alcohols, fatty acids, organofluorine compounds and mixtures thereof. The amount of such antifoam may depend on the type of antifoam and, if present, is typically in the range of 0.01 to 0.5 wt.-%, based on the total weight of the formulation.

Suitable preservatives to prevent microbial spoiling of the compositions of the invention include formaldehyde, alkyl esters of p-hydroxybenzoic acid, sodium benzoate, 2-bromo-2-nitropropane-1,3-diol, o-phenylphenol, thiazolinones, such as 1,2-benzisothiazol-3 (2H)-one, 5-chloro-2-methyl-4-isothiazolinone (CIT), methylisothiazolinon (MIT) pentachlorophenol, 2,4-dichlorobenzyl alcohol and mixtures thereof. Commercially available preservatives that are based on isothiazolinones are for example marketed under the trademarks Proxel® (Arch Chemical), Acticide® grades, such as MV, MBS and B20 (Thor Chemie) and Kathon® MK (Rohm & Haas). 2-bromo-2-nitropropane-1,3-diol is commercially available as Acticide® L30.

The formulations of the present invention can be simply prepared by mixing the components A), B) (if present), C) and D), whereby a solution of the component A in the mixture of components B) (if present), C) and D) is obtained. For example it may be possible to first dissolve the component A) in the component C) or in the solvent C.1 and mix the remaining components with the solution.

The formulation of the present invention are suitable for controlling undesired plant growth, in particular undesired plant growth in crop. For this, the aqueous formulation is applied to the undesired plants or to an area where the undesired plants will grow.

The formulation of the invention can be applied in numerous crops. The crops include in particular field corn, including field corn grown for producing grain, seed or silage, popcorn, sweet corn, soybean, chickpea, edible pea, field pea, lentils, including green and red type, perennial grasses, in particular when grown for seed production, alfalfa, in particular in established stands of dormant alfalfa, in cereals, legume and oilseed cover crops. The formulations are active against broad-leaved weeds and grass weeds without inflicting substantial damage to the crop plants. For this, the formulations and the combinations of the invention are preferably applied pre-emergently, i. e. before the undesired plants emerge. Pre-emergent application in crops may be carried out shortly before or shortly after the crop has been planted but preferably before the crop plants emerge.

The formulation of the invention can be applied in crops which have been modified by mutagenesis or genetic engineering in order to provide a new trait to a plant or to modify an already present trait. Mutagenesis includes techniques of random mutagenesis using X-rays or mutagenic chemicals, but also techniques of targeted mutagenesis, in order to create mutations at a specific locus of a plant genome. Targeted mutagenesis techniques frequently use oligonucleotides or proteins like CRISPR/Cas, zinc-finger nucleases, TALENs or meganucleases to achieve the targeting effect. Genetic engineering usually uses recombinant DNA techniques to create modifications in a plant genome which under natural circumstances cannot readily be obtained by cross breeding, mutagenesis or natural recombination. Typically, one or more genes are integrated into the genome of a plant in order to add a trait or improve a trait. These integrated genes are also referred to as transgenes in the art, while plant comprising such transgenes are referred to as transgenic plants. The process of plant transformation usually produces several transformation events, which differ in the genomic locus in which a transgene has been integrated. Plants comprising a specific transgene on a specific genomic locus are usually described as comprising a specific “event”, which is referred to by a specific event name. Traits which have been introduced in plants or have been modified include in particular herbicide tolerance, insect resistance, increased yield and tolerance to abiotic conditions, like drought.

Examples of genetically modified crops in which the formulations and combinations can be used include in particular corn and soybean: Transgenic soybean events comprising herbicide tolerance genes are for example, but not excluding others, GTS 40-3-2, MON87705, MON87708, MON87712, MON87769, MON89788, A2704-12, A2704-21, A5547-127, A5547-35, DP356043, DAS44406-6, DAS68416-4, DAS-81419-2, GU262, SYHTØH2, W62, W98, FG72 and CV127.

Transgenic cotton events comprising herbicide tolerance genes are for example, but not excluding others, 19-51a, 31707, 42317, 81910, 281-24-236, 3006-210-23, BXN10211, BXN10215, BXN10222, BXN10224, MON1445, MON1698, MON88701, MON88913, GHB119, GHB614, LLCotton25, T303-3 and T304-40.

The formulations of the invention provide a very good control of vegetation during the fallow period, i. e. the period following harvest and before the following crop is planted.

The formulations of the invention provide a very good control of vegetation also in non-crop areas, especially at high application rates.

The formulations of the invention provide a very good control of the following plants, including
broadleaf weeds, such as Amaranth, Palmer (Amaranthus palmeri), Amaranth, Powell (Amaranthus powellii), Bedstraw, catchweed (Galium aparine), Beggarticks, hairy (Bidens pilosa), Beggarweed, Florida (Desmodium tortuosum), Bindweed, field (Convolvulus arvensis), Buckwheat, wild (Polygonum convolvulus), Buffalobur (Solanum rostratum) C. Burcucumber (Sicyos angulatus) S, Canola, volunteer (rapeseed), all types (Brassica spp.), Carpetweed (Mollugo verticillata), Chamomile, mayweed (Anthemis cotula), Chickweed, common (Stellaria media), Cocklebur, common (Xanthium strumarium), Copperleaf, Virginia (Acalypha virginica), Cotton, volunteer (Gossypium hirsutum), Cowcockle (Vaccaria pyramidata), Dandelion (Taraxacum officinale), Devil's-claw (Proboscidea Louisiana), Eclipta (Eclipta prostrata), Eveningprimrose, cutleaf (Oenothera laciniata), Galinsoga, smallflower (Galinsoga parviflora), Falseflax, smallseed (Camelina macrocarpa), Filaree, redstem (Erodium cicutarium), Fleabane, hairy (Conyza bonariensis), Flixweed (Descurainia sophia), Groundcherry, cutleaf (Physalis angulate), Groundsel, common (Senecio vulgaris), Hawksbeard, narrowleaf (Crepis tectorum), Hemlock, poison (Conium maculatum), Henbit (Lamium amplexicaule), Horseweed (marestail) (Conyza canadensis), Jimsonweed (Datura stramonium), Knotweed, prostrate (Polygonum aviculare), Kochia (Kochia scoparia), Ladysthumb (Polygonum persicaria), Lambsquarters, common (Chenopodium album), Lambsquarters, narrowleaf (Chenopodium pratericola), Lettuce, prickly (Lactuca serriola), Mallow, common (Malva neglecta), Mallow, little (cheeseweed) (Malva parviflora), Mallow, Venice (Hibiscus trionum), Marestail (horseweed) (Conyza canadensis), Morningglory, entireleaf (Ipomoea hederacea var. integriuscula), Morningglory, ivyleaf (Ipomoea hederacea), Morningglory, palmleaf (Ipomoea wrightii), Morningglory, pitted (pomoea lacunose), Morningglory, tall (Ipomoea purpurea), Mustard, black (Brassica nigra), Mustard, tumble (Sisymbrium altissimum), Mustard, wild (Sinapis arvensis), Nettle, burning (Urtica urens), Nightshade, black (Solanum nigrum), Nightshade, cutleaf (Solanum triflorum), Nightshade, Eastern black (Solanum ptycanthum), Nightshade, hairy (Solanum sarrachoides), Parthenium (Parthenium hysterophorus), Pennycress, field (Thlaspi arvense), Pigweed, prostrate (Amaranthus blitoides), Pigweed, redroot (Amaranthus retroflexus), Pigweed, smooth (Amaranthus hybridus), Pigweed, tumble (Amaranthus albus), Puncturevine (Tribulus terrestris), Purslane, common (Portulaca oleracea), Pusley, Florida (Richardia scabra), Ragweed, common (Ambrosia artemisiifolia), Ragweed, giant (Ambrosia trifida), Rocket, London (Sisymbrium irio), Sesbania, hemp (Sesbania exaltata), Shepherds-purse (Capsella bursa-pastoris), Sida, prickly (Sida spinosa), Smartweed, Pennsylvania (Polygonum pensylvanicum), Sowthistle, annual (Sonchus arvensis), Spurge, nodding (Chamaesyce nutans), Spurge, spotted (Chamaesyce maculate), Starbur, bristly (Acanthospermum hispidum), Sunflower, common (Helianthus annuus), Tansymustard, pinnate (Descurainia pinnata), Texasweed (Caperonia palustris), Thistle, Canada (Cirsium arvense), Thistle, Russian (Salsola kali), Velvetleaf (Abutilon theophrasti), Waterhemp (Amaranthus tuberculatus) and Willowweed (Epilobium adenocaulon);
Annual grass weeds, such as Barley, hare (Hordeum murinum spp. leporinum); Barnyardgrass (Echinochloa crus-galli), Bluegrass, annual (Poa annua), Bluegrass, roughstalk (Poa trivialis), Brome, California (Bromus carinatus), Brome, downy (Bromus tectorum), Brome, Japanese (Bromus japonicus), Canarygrass (Phalaris canariensis), Cheat (Bromus secalinus), Crabgrass, large (Digitaria sanguinalis), Crabgrass, smooth (Digitaria ischaemum), Crowfootgrass (Dactyloctenium aegyptium), Cupgrass, Southwestern (Eriochloa gracilis), Cupgrass, woolly (Eriochloa villosa), Fescue, rattail (Vulpia myuros), Foxtail, giant (Setaria faberi), Foxtail, green (Setaria viridis), Foxtail, yellow (Setaria pumila), Goosegrass (Eleusine indica), Johnsongrass (seedling) (Sorghum halepense), Millet, Texas (Urochloa texana), Millet, wild proso (Panicum miliaceum), Oat, wild (Avena fatua), Panicum, fall (Panicum dichotomiflorum), Panicum, Texas (Panicum texanum), Rice, red (Oryza sativa), Ryegrass, Italian (Lolium multiflorum), Ryegrass, rigid (Lolium rigidum), Sandbur (Cenchrus spp.), Shattercane (Sorghum bicolor), Signalgrass, broadleaf (Brachiaria platyphylla), Witchgrass (Panicum capillare), Flatsedge, rice (Cyperus iria) and Nutsedge, yellow (Cyperus esculentus).

The application of the formulation of the invention may vary depending on the rate may depend on the kind of ground to which the formulation is applied is typically in the range of 0.02 to 1.5 kg/h, in particular in the range of 0.03 to 1 kg/ha.

The application rates of the PPO inhibitor is typically in the range of 10 to 300 g/ha, in particular in the range of 15 to 200 g/ha.

The formulations of the present invention may be applied preplant, preemergence, or as burndown application, in particular in the fall. Preplant application may be done to the surface or by incorporating the formulation or the individual herbicides of the combination into the ground.

Preplant surface application is typically carried out by applying a uniform broadcast to the soil surface. Preplant surface application is usually carried out within 30 days of planting and before crop emergence. For preplant incorporated (PPI) application the formulation or the individual herbicides of the combination are usually incorporated into the upper soil surface, e. g. into a depth of 2 to 6 cm, preferably within 14 days of planting. Incorporation may be carried out by shallow incorporation, including a field cultivator, harrow, rolling cultivator, or finishing disc.

The application of the formulation of the invention may be carried out using water or a fluid nitrogen fertilizer as a spray carrier. For this, the respective formulations are diluted with water or the liquid nitrogen fertilizer to obtain a liquid spray liquor. Frequently, the amount of water used is at least 20 L/ha, in particular at least 25 L/ha and may be as high as 1000 L/ha.

The spray liquors can be applied in conventional manner by using techniques as skilled person is familiar with. Suitable techniques include spraying, atomizing, dusting, spreading or watering. The type of application depends on the intended purpose in a well-known manner; in any case, they should ensure the finest possible distribution of the active ingredients according to the invention.

It is also possible to apply the formulations of the present invention in the form of fertilizer granules which have been impregnated with the formulations of the present invention.

To achieve a broader activity spectrum it may be possible to co-apply the formulation of the present invention with a further herbicide.

The formulation of the present invention may be applied together with an adjuvant as action improver. A particular preferred adjuvant is described in WO 00/53014 and in WO2010/037734. Said adjuvant is a combination of a C₁-C₅-alkyl C₅-C₂₂-alkanoate, a C₁₀-C₂₀-carboxylic acid, a partial phosphoric or sulfuric acid ester of a monohydroxy-functional polyalkyl ether and an alkyl polyoxyalkylene polyether. Preferred C₁-C₅-alkyl C₅-C₂₂-alkanoates are methyl oleate, methyl palmitate and ethyl oleate and mixtures thereof. Specifically, the C₁-C₅-alkyl C₅-C₂₂-alkanoate comprises at least 70% by weight of methyl oleate or of a mixture of methyl oleate and methyl palmitate. Such action improver systems are commercially available under the name DASH®, e.g. DASH® HC, from BASF Corporation, USA. Further action improvers include but are not limited to those adjuvants conventionally used in combination with glyphosate, such as non-ionic surfactants (NIS), ammonium sulfate, alkyl sulfates of C₆₋₁₈ alkanols such as sodium dodecyl sulfate, alkyl ether sulfates of C₆₋₁₈ alkanols, methylated soybean oil (MSO) and crop oil concentrate (COC).

The following examples are intended to further illustrate the present invention without limiting its scope in any way.

The invention is elucidated in more detail by the examples hereinafter.

### EXAMPLES

### Preparing the Liquid Formulation

The following ingredients were used:
Emulsifier C3a: Oleyl alcohol ethoxylate (Emulsogen M; Clariant International Ltd)
Emulsifier C3b: Isotridecyl alcohol ethoxylate (Lutensol TO5; BASF SE)
Emulsifier C3c: C₁₀-C₁₈ alkanol ethoxylate (ethoxylated with 5 EO) (Lutensol M5, BASF)
Emulsifier C4a: Tristyryl phenol ethoxylate (Soprophor BSU; Solvay SA)
Component C5a: Methylated rape seed oil (Agnique ME 18 RD-F; BASF SE)
Component C5b: methyl caprylate (Agnique ME 890)

Liquid formulations of the inventive examples 1 to 8 were formulated according to the following procedure:

DMSO was charged into a vessel, saflufenacil was added and the mixture was mixed until saflufenacil was dissolved. Then the emulsifiers and all the other ingredients were added in the required amounts and the mixture was mixed until homogenous.

TABLE 1
Formulation examples 1 to 5 comprising component B

| | | Amount [% by weight*] | | | | |
|---|---|---|---|---|---|---|
| | | Example | Example | Example | Example | Example |
| Components | | 1 | 2 | 3 | 4 | 5 |
| Component A | Saflufenacil | 9.4 | 9.4 | 9.5 | 9.5 | 9.5 |
| Component B | Acetic acid | 0.9 | 0.9 | 0.04 | 0.04 | 0.04 |
| Component C1 | Water | 1.9 | 0.9 | 0.5 | 0.7 | 0.9 |
| Component C2 | DMSO | 31.9 | 31.8 | 29.96 | 33.36 | 43.86 |
| Component C3 | Emulsifier | 12.5 | 3.2 | 11.7 | — | — |
| | C3a | | | | | |
| | Emulsifier | 2.8 | 9.7 | 11.7 | 19.8 | — |
| | C3b | | | | | |
| | Emulsifier | — | — | — | — | 5.9 |
| | C3c | | | | | |
| Component C4 | Emulsifier | 15.3 | 18.5 | 11.7 | 9.9 | 5.9 |
| | C4a | | | | | |
| Component C5 | C5a | 25.3 | 25.6 | — | — | — |
| | C5b | — | — | 24.9 | 26.7 | 33.9 |

*Weight ratio based on the total weight of the formulation

TABLE 2
Formulation examples 6 to 8 not comprising component B

| | | Amount [% by weight*] | | |
|---|---|---|---|---|
| Components | | Example 6 | Example 7 | Example 8 |
| Component A | Saflufenacil | 9.7 | 9.7 | 5.0 |
| Component C1 | Water | 2.0 | 2.0 | 2.0 |
| Component C2 | DMSO | 33.1 | 33.1 | 33.8 |
| Component C3 | Emulsifier C3a | 11.2 | 11.2 | 11.5 |
| | Emulsifier C3b | 16.5 | 11.2 | 17.3 |
| Component C4 | Emulsifier C4a | 4.9 | 11.2 | 5.7 |
| Component C5 | C5a | 22.6 | 21.6 | 24.7 |

*Weight ratio based on the total weight of the formulation

### Analytical Methods

### 1.1 Particle Diameter (Particle Size)

The average particle diameter of the particles in the liquid formulation may also be determined by dynamic light scattering (DLS) as described above, using a Malvern HPPS.

### 1.2 Light Transmittance

Light transmittance (LD100 value) of the liquid formulation was determined by measuring the transmission light intensity at 525 nm and 1 cm cuvette using the respective polymer dispersion “as is”, i.e. in its undiluted form, with Photometer DR 6000 (Hach Lange). The light diffusion factor (LD100 value in %) depicts how much of the light is transmitting the sample at a given cuvette length respective to pure water which exhibits a LD100 value of 100.

### 1.3 Degradation of the Component a (Saflufenacil)

Degradation of saflufenacil was determined by ultra high pressure liquid chromatography (UPLC).

### 1.4 Dilution Stability of the Liquid Formulation

Dilution stability was determined by the CIPAC MT 36.3 test.

### 1.5 Viscosity

Viscosity was determined by the CIPAC MT 192 test (rotational viscometry); shear rate 100 s⁻¹.

### Results

According to visual inspection, the liquid formulations of examples 1 to 8 are homogeneous liquids at room temperature.

In case of the formulations of examples 1 and 2, homogeneity at room temperature was moreover confirmed by determination of the particle size and the light transmittance.

After storage for 2 weeks at +54° C. or for 8 weeks at 80° C., saflufenacil degradation is less than 1% in each of the liquid formulations of examples 1 to 8.

In case of the formulations of examples 1 and 2, after storage for 2 weeks at +54° C., a 1% dilution thereof in deionized water was prepared, resulting in a turbid spray dispersion which is stable for several hours.

Further results are compiled in the following stability test chapter.

### Stability Tests

The stability of some representative formulations was investigated according to industry standard tests from the CIPAC methods (tapered cylinder test according to CIPAC MT 36.3). Some formulations were moreover kept at 54° C. for 2 weeks (2w 54° C.) and at 40° C. for 8 weeks (8w 40° C.). To investigate storage stability overtime, the properties were determined directly after preparing the compositions and after storage.

The degree of homogeneity and the formation of serum and of sediment was evaluated by visual inspection.

The results are compiled in table 3.

TABLE 3

| | | | | | |
|---|---|---|---|---|---|
| Ex. | 1 | 2 | 6 | 7 | 8 |

Visual inspection

| | | | | | |
|---|---|---|---|---|---|
| initial | clear, liquid | clear, liquid | clear, liquid | clear, liquid | clear, liquid |

Tapered cylinder test 1% (ex. 1, 2) or 2% (ex. 6-8) in Cipac standard water D

| | | | | | |
|---|---|---|---|---|---|
| Initial | ts | ts | s | s | ts |
| 0.5 h | 0.05 ml Bs | 0.05 ml Bs | 0.05 ml Bs | 0.05 ml Bs | <0.05 ml R |
| 1 h | 0.05 ml Bs | 0.05 ml Bs | 0.10 ml Bs | 0.10 ml Bs | <0.05 ml R |
| 2 h | 0.05 ml Bs | 0.10 ml Bs | 0.70 ml Bs | 0.70 ml Bs | <0.05 ml R, |
| | | | | | <0.5 ml Bs |
| 2 w 54 °C | n.d. | n.d. | s | s | n.d. |
| 0.5 h | n.d. | n.d. | <0.05 ml Bs | <0.05 ml Bs | n.d. |
| 1 h | n.d. | n.d. | <0.05 ml Bs | <0.05 ml Bs | n.d. |
| 2 h | n.d. | n.d. | <0.05 ml Bs | 0.60 ml Bs | n.d. |
| 8 w 40 °C | n.d. | n.d. | s | s | n.d. |
| 0.5 h | n.d. | n.d. | <0.05 ml Bs | <0.05 ml Bs | n.d. |
| 1 h | n.d. | n.d. | <0.05 ml Bs | <0.05 ml Bs | n.d. |
| 2 h | n.d. | n.d. | 0.10 ml Bs | 0.05 ml Bs | n.d. |

Viscosity [mPas]

| | | | | | |
|---|---|---|---|---|---|
| Initial | n.d. | n.d. | 17 | 15 | n.d. |
| 2 w 54 °C | n.d. | n.d. | 15 | 17 | n.d. |
| 8 w 40 °C | n.d. | n.d. | 17 | 14 | n.d. |

pH

| | | | | | |
|---|---|---|---|---|---|
| Initial | n.d. | n.d. | 6.97 | 6.9 | n.d. |
| 2 w 54 °C | n.d. | n.d. | 6.70 | 6.0 | n.d. |

Visual inspection

| | | | | | |
|---|---|---|---|---|---|
| 8 w 40 °C | n.d. | n.d. | 6.05 | 5.9 | n.d. |

n.d. not determined
Bs sediment
Sp Bs traces of sediment
R serum
s self-emulsifying (after 3 shakes)
ts partially self-emulsifying (after 3 shakes)

As can be seen, the tested formulations are stable overtime, even under harsher conditions. Generally, a formation of up to 2 ml of sediment is considered as acceptable. The tested formulations show distinctly less sediment formation. Viscosity of the tested formulations is essentially unchanged. The changes in the pH values are within tolerable ranges.

1. A liquid agricultural formulation containing
a) at least one herbicide of the group of PPO-inhibitors, as a component A),
b) optionally at least one organic acid having a pKA value in the range of 1 to 6, in particular in the range of 3 to 5, as a component B), and
c) a solvent-emulsifier combination, as a component C), comprising
c1) water, as a component C1),
c2) at least one water-miscible organic solvent, as a component C2),
c3) at least one first emulsifier, as a component C3), selected from the group consisting of C₆-C₂₅-alkanol alkoxylates, C₆-C₂₅-alkenol alkoxylates and mixtures thereof,
c4) at least one second emulsifier, as a component C4), selected from the group consisting of arylphenol ethoxylates and mixtures thereof, and
c5) at least one C₆-C₂₀-fatty acid-C₁-C₄-alkyl ester, in particular at least one C₆-C₂₀-fatty acid methyl or ethyl ester, as a component C5).

2. The formulation according to claim 1, wherein the component A) is saflufenacil and/or trifludimoxazin.

3. The formulation according to claim 1, wherein the component A) is saflufenacil.

4. The formulation according to any one of the preceding claims, wherein the component B) is a C₁-C₄-alkanoic acid.

5. The formulation according to claim 4, wherein the component B) is acetic acid.

6. The formulation according to any one of the preceding claims, which comprises:
if component B) is present:
1 to 30% by weight, in particular 4 to 25% by weight, based on the total weight of the formulation, of the component A),
0.01 to 5% by weight, in particular 0.03 to 4% by weight, based on the total weight of the formulation, of the component B), and
65 to 98.99% by weight, in particular 71 to 95.97% by weight, based on the total weight of the formulation, of the component C); and
if component B) is not present:
1 to 30% by weight, in particular 4 to 25% by weight, based on the total weight of the formulation, of the component A), and
70 to 99% by weight, in particular 75 to 96% by weight, based on the total weight of the formulation, of the component C).

7. The formulation according to any one of the preceding claims, wherein one, two or all three of the following conditions a), b) and/or c) apply:
a) the component C) comprises, based in each case on the total weight of the component C),
components C1) and C₂) in a total amount in the range of 10 to 85% by weight, preferably 20 to 60% by weight, more preferably 20 to 50% by weight,
components C3) and C₄) in a total amount in the range of 5 to 85% by weight, preferably 10 to 50% by weight, more preferably 10 to 40% by weight,
component C5) in a total amount in the range of 5 to 80% by weight, preferably 10 to 60% by weight, more preferably 20 to 40% by weight;
and/or
b) the relative amounts of the components C1) and C₂) are as follows:
0.5 to 20% by weight, preferably 1 to 10% by weight, based on the total weight of the components C1) and C₂), of the component C1), and
80 to 99.5% by weight, preferably 90 to 99% by weight, based on the total weight of the components C1) and C₂), of the component C2);
and/or
c) the relative amounts of the components C3) and C₄) are as follows:
30 to 90% by weight, preferably 35 to 90% by weight, based on the total weight of the components C3) and C₄), of the component C3), and
10 to 70% by weight, preferably 10 to 65% by weight, based on the total weight of the components C3) and C₄), of the component C4).

8. The formulation according to any one of the preceding claims, wherein the component C2) is selected from the group consisting of 1-methoxy-2-propyl acetate, C₁-C₄-alkyl lactates, C₁-C₄-alkyl lactamides, di-(C₁-C₂-alkyl) lactamides, N—C₁-C₄-alkyl-2-pyrrolidones, epsilon-caprolactam, C₄-C₆-lactones, C₂-C₄-alkylene carbonates, dimethyl sulfoxide, N,N-dimethylimidazolin-2-one and mixtures thereof.

9. The formulation according to claim 8, wherein the component C2) comprises or consists of dimethyl sulfoxide.

10. The formulation according to any one of the preceding claims, wherein the component C3) is selected from the group consisting of C₈-C₂₀-alkanol-C₂-C₄-alkoxylates and C₈-C₂₀-alkenol-C₂-C₄-alkoxylates and mixtures thereof, wherein the degree of alkoxylation is in the range of 1 to 10, particularly in the range of 2 to 7, especially in the range of 3 to 5;
wherein preferably the C₈-C₂₀-alkanol-C₂-C₄-alkoxylates and C₈-C₂₀-alkenol-C₂-C₄-alkoxylates are ethoxylates or ethoxyxlate-co-propoxylates.

11. The formulation according to any one of the preceding claims, wherein the component C4) is selected from the group consisting of distyrylphenol ethoxylates, tristyrylphenol ethoxylates and mixtures thereof, preferably from tristyrylphenol ethoxylates.

12. The formulation according to any one of the preceding claims, wherein the degree of ethoxylation of the component C4) is in the range of 1 to 30, particularly in the range of 5 to 20, especially in the range of 10 to 18.

13. The formulation according to any one of the preceding claims, wherein the component C5) comprises at least one unsaturated C₁₈-fatty acid-C₁-C₄-alkyl ester;
wherein preferably the component C5) comprises at least 60% by weight, based on the total weight of the component C5), of the at least one unsaturated C₁₈-fatty acid-C₁-C₄-alkyl ester,
wherein in particular the component C5) comprises, based on the total weight of the component C5),
not more than 21% by weight of C₁₀-C₁₇-fatty acid-C₁-C₄-alkyl esters,
not more than 2% by weight of C₁₉-C₂₀-fatty acid-C₁-C₄-alkyl esters,
not more than 8% by weight of C₁-C₄-alkyl palmitate, and
not more than 4% by weight of C₁-C₄-alkyl stearate.

14. The formulation according to any one of the preceding claims, wherein the component C5) is a methylated plant oil or a mixture of methylated plant oils, in particular selected from the group consisting of methylated rapeseed oil, methylated sunflower oil, methylated soybean oil, methylated peanut oil, methylated olive oil, methylated corn oil, methylated grape seed oil, methylated safflower oil, methylated sesame oil, methylated buriti oil, methylated canola oil, and methylated hemp seed oil; and is specifically methylated rapeseed oil.

15. The formulation according to any one of claims 1 to 12, wherein the component C₅) comprises or consists of a C₆-C₁₀-fatty acid methyl ester.

16. The formulation according to any one of the preceding claims, which comprises:
4 to 11% by weight, based on the total weight of the formulation, of saflufenacil (component A);
0 to 1.5% by weight, based on the total weight of the formulation, of acetic acid (component B);
0.1 to 2.5% by weight, based on the total weight of the formulation, of water (component C1);
25 to 50% by weight, preferably 28 to 45% by weight, based on the total weight of the formulation, of DMSO (component C2);
5 to 30% by weight, based on the total weight of the formulation, of one or more alcohol ethoxylates selected from C₁₀-C₁₈-alkanol ethoxylates, C₁₀-C₁₈-alkenol ethoxylates and mixtures thereof, wherein the degree of ethoxylation of the alkanol ethoxylates and alkenol ethoxylates is in the range of 1 to 10, preferably in the range of 2 to 10, e.g. 3 to 10; more preferably in the range of 2 to 7, especially in the range of 3 to 5 (component C3);
4-20% by weight of distyrylphenol ethoxylates, tristyrylphenol ethoxylates or mixtures thereof, each having a degree of ethoxylation in the range of 1 to 30, particularly in the range of 5 to 20, especially in the range of 10 to 18; preferably 4-20% by weight of tristyrylphenol ethoxylates having a degree of ethoxylation in the range of 1 to 30, particularly in the range of 5 to 20, especially in the range of 10 to 18 (component C4); and
20 to 35% by weight of a methylated plant oil or a mixture of methylated plant oils, where the methylated plant oils are preferably selected from thr group consisting of methylated rapeseed oil, methylated sunflower oil, methylated soybean oil, methylated peanut oil, methylated olive oil, methylated corn oil, methylated grape seed oil, methylated safflower oil, methylated sesame oil, methylated buriti oil, methylated canola oil, methylated hemp seed oil, and mixtures thereof;
or
20 to 35% by weight of at least one saturated C₆-C₁₀-fatty acid methyl ester, preferably comprising methyl caprylate in an amount of at least 50% by weight of all C₆-C₁₀-fatty acid methyl esters (component C5).

17. The formulation according to claim 16, which comprises:
4 to 11% by weight, based on the total weight of the formulation, of saflufenacil (component A);
0 to 1.5% by weight, based on the total weight of the formulation, of acetic acid (component B);
0.1 to 2.5% by weight, based on the total weight of the formulation, of water (component C1);
28 to 45% by weight, based on the total weight of the formulation, of DMSO (component C2);
5 to 30% by weight, based on the total weight of the formulation, of one or more alcohol ethoxylates selected from C₁₀-C₁₈-alkanol ethoxylates, C₁₀-C₁₈-alkenol ethoxylates and mixtures thereof, wherein the degree of ethoxylation of the alkanol ethoxylates and alkenol ethoxylates is in the range of 1 to 10, preferably in the range of 2 to 10, e.g. 3 to 10; more preferably in the range of 2 to 7, especially in the range of 3 to 5 (component C3);
4-20% by weight of tristyrylphenol ethoxylates having a degree of ethoxylation in the range of 10 to 18 (component C4); and
20 to 35% by weight of methylated rapeseed oil or of methyl caprylate; preferably 20 to 30% by weight of methylated rapeseed oil.

18. A process for preparing the liquid formulationaccording to any one of the preceding claims, which comprises mixing the components A), C) and optionally B).

19. Use of the liquid formulation according to any one of claims 1 to 17 for controlling growth of undesired plants.

20. A method for controlling growth of undesired plants comprising the step of applying the formulation according to any one of claims 1 to 17 onto the undesired plants, on parts of the undesired plants or on the area where the undesired plants grow or may grow.
